(19) United States
(12) Patent Application Publication
(10) Pub. No.: US 2025/0316282 A1
(43) Pub. Date: Oct. 9, 2025

(54) ERROR RESILIENT TOOLS FOR AUDIO ENCODING/DECODING

(71) Applicant: FRAUNHOFER-GESELLSCHAFT ZUR FÖRDERUNG DER ANGEWANDTEN FORSCHUNG E.V., München (DE)

(72) Inventors: Kishan GUPTA, Erlangen (DE); Nicola PIA, Erlangen (DE); Srikanth KORSE, Erlangen (DE); Guillaume FUCHS, Erlangen (DE); Markus MULTRUS, Erlangen (DE); Markus SCHNELL, Erlangen (DE); Andreas BRENDEL, Erlangen (DE)

(21) Appl. No.: 19/243,429

(22) Filed: Jun. 19, 2025

Related U.S. Application Data
(63) Continuation of application No. PCT/EP2023/085982, filed on Dec. 14, 2023.

(30) Foreign Application Priority Data
Dec. 23, 2022 (WO) PCT/EP2022/087807

(51) Int. Cl. G10L 19/032; G10L 19/00

(52) U.S. Cl. CPC G10L 19/032; G10L 2019/0004

(57) ABSTRACT

There are provided examples of audio signal representation encoders, audio encoders, audio signal representation decoders, and audio decoders, in particular using error resilient tools, e.g. for learnable applications.

In one examples, there is provided an audio signal representation decoder configured to decode an audio signal representation from a bitstream, the bitstream being divided in a sequence of packets, the audio signal representation decoder comprising:
a bitstream reader, configured to sequentially read the sequence of packets;
a packet loss controller, configured to check whether a current packet is well received or is to be considered as lost;
a quantization index converter, configured, in case the packet loss controller has determined that the current packet is well received, to convert at least one index extracted from the current packet onto at least one current code from at least one codebook, thereby forming at least one portion of the audio signal representation; and
wherein the audio signal representation decoder is configured, in case the packet loss controller has determined that the current packet is to be considered as lost, to generate, through at least one learnable predictor layer, at least one current code by prediction from at least one preceding code or index, thereby forming at least one portion of the audio signal representation.

### CROSS-REFERENCES TO RELATED APPLICATIONS

This application is a continuation of copending International Application No. PCT/EP2023/085982, filed Dec. 14, 2023, which is incorporated herein by reference in its entirety, and additionally claims priority from International Application No. PCT/EP2022/087807, filed Dec. 23, 2022, which is incorporated herein by reference in its entirety.

There are provided examples of audio signal representation encoders, audio encoders, audio signal representation decoders, and audio decoders, in particular using error resilient tools, e.g. for learnable applications (e.g., using neural networks). In particular, there are described error resilient tools for neural end-to-end speech codecs, such as forward error correction (FEC) and packet loss concealment (PLC).

### BACKGROUND OF THE INVENTION

Error resilient tools like Packet Loss Concealment (PLC) and Forward Error Correction (FEC) has been implemented for conventional speech codec system. For application like VoIP, where frequent packet losses and delays are unavoidable, such tools play a crucial role in maintaining the quality of service for end-users. In recent times, deep neural network (DNN) based speech codec has seen a significant rise, due to their ability to transmit speech signal at very low bitrates. Recently proposed, Neural End-to-End Speech Codec (NESC) efficiently encode the speech signal at low bitrate of 3.2 kbps and lower, and is robust to noisy and reverberant speech signal (description of NESC is carried out, in particular in FIGS. 9-13 and the related description). Extending the robustness of NESC to packet losses, we propose an autoregressive neural network to perform packet loss concealment along with a low bitrate forward error correction at additional bitrate which can be as low as 0.8 kbps. Our method works on the latent representation of the NESC and is trained independent of the codec.

Real-time VoIP communications are highly sensitive to network conditions and congestions, resulting in packet loss or large delays in packet arrival. The decoder should be capable of handling such losses and conceal the lost packet to maintain good quality of service. Basic Packet Loss Concealment (PLC) techniques included methods like silencing the lost frame, repeating the pitch lag or some form of extrapolation. More advance state of the art communication codecs like Enhanced Voice Service (EVS) supports two types of error resilient tools, one being the Packet Loss Concealment that extrapolates coded parameters from the previous frames like the Line Spectral Frequency (LSF), pitch information of future frame sent for the lost frames with additional transmitted information, the other being the Forward Error Correction (FEC) where features of distant past frames are coarsely quantized and piggy-backed on future frames[1][2]. Transmitting redundant information in anticipation of a loss has to be done with cares since it puts additional strain on a network connection and could engender additional latency.

In recent times, neural network-based system has shown unprecedented rise and outperformed conventional systems in various fields such as speech enhancement, speech coding, speech synthesis etc. Similarly, DNN based PLC models like WaveNetEQ [3], PLAAE[4], LPCNet based PLC[5], [6] etc. has shown to outperform conventional concealment methods over large burst and higher error rates. Most of these methods performs concealment directly on speech signal in a post-processing way, whereas recently proposed LPCNet Based PLC model predicts features of the future frame and generates concealed signal with autoregressive LPCNet[8].

Limits of post-processing (DNN-based) PLC:
PLC model agnostic of the coding scheme, need fine-tuning and adjustment for supporting optimally different codecs.
Well received frames may be affected by the post-processing step
Over-head of complexity and latency
Recovery capability limited to codec's quality->no joint training possible between PLC and coding modules.

We propose a solution even more integrated within the neural coding scheme than [6] and less complex and less intrusive, by doing the concealment in the quantization domain within the inverse quantization scheme.

On the other hand, no or very few specific FEC solutions for neural coding was proposed till now for neural coders.

### REFERENCES

[1] Anssi Ramo and Antti Kurittu and Henri Toukomaa, “EVS Channel Aware Mode Robustness to Frame ErasureEVS Robustness to Frame Erasures”. 2553-2557. 10.21437/Interspeech.2016-917.
[2] C. Rao and S. Zhao, “Multiple additional bit-rate channel-aware modes in EVS codec for packet loss recovery,” 2019 IEEE International Conference on Signal, Information and Data Processing (ICSIDP), 2019, pp. 1-5, doi: 10.1109/ICSIDP47821.2019.9173341.
[3] F. Stimberg et al., “WaveNetEQ—Packet Loss Concealment with WaveRNN,” 2020 54th Asilomar Conference on Signals, Systems, and Computers, 2020, pp. 672-676, doi: 10.1109/IEEECONF51394.2020.9443419.
[4] Pascual, Santiago, Joan Serrà, and Jordi Pons. “Adversarial auto-encoding for packet loss concealment.” 2021 IEEE Workshop on Applications of Signal Processing to Audio and Acoustics (WASPAA). IEEE, 2021.
[5] Valin, J. M., Mustafa, A., Montgomery, C., Terriberry, T. B., Klingbeil, M., Smaragdis, P., & Krishnaswamy, A. (2022). Real-Time Packet Loss Concealment With Mixed Generative and Predictive Model. arXiv preprint arXiv:2205.05785.
[6] Xue, Huaying, Xiulian Peng, Xue Jiang, and Yan Lu. “Towards Error-Resilient Neural Speech Coding.” arXiv preprint arXiv:2207.00993 (2022).
[7] Pia, N., Gupta, K., Korse, S., Multrus, M., & Fuchs, G. (2022). NESC: Robust Neural End-2-End Speech Coding with GANs. arXiv preprint arXiv:2207.03282.
[8] J. Valin and J. Skoglund, A Real-Time Wideband Neural Vocoder at 1.6 kb/s Using LPCNet. arXiv:1903.12087.
[9] J. Wang, Y. Guan, C. Zheng, R. Peng, and X. Li, “A temporal spectral generative adversarial network based end-to-end packet loss concealment for wideband speech transmission,” The Journal of the Acoustical Society of America, vol. 150, no. 4, pp. 2577-2588, 2021.

### SUMMARY

An embodiment may have an encoder, comprising: an audio signal representation generator configured to generate, through at least one learnable layer, an audio signal representation as a representation of an audio signal, the audio signal representation comprising a sequence of tensors; a quantizer configured to convert each current tensor of the sequence of tensors onto at least one index, wherein each index is obtained from at least one codebook associating a plurality of tensors to a plurality of indexes; a bitstream writer configured to write packets in the bitstream, so that a current packet comprises the at least one index for the current tensor of the sequence of tensors, wherein the encoder is configured to write redundancy information of the current tensor in at least one preceding or following packet of the bitstream different from the current packet and/or to write, in the current packet, redundancy information of a tensor, different from the current tensor, in the current packet.

Another embodiment may have a method comprising: generating, through at least one learnable layer, an audio signal representation as a representation of an audio signal, the audio signal representation comprising a sequence of tensors; converting each current tensor of the sequence of tensors onto at least one index, wherein each index is obtained from at least one codebook associating a plurality of tensors to a plurality of indexes; writing packets in a bitstream, so that a current packet comprises the at least one index for the current tensor of the sequence of tensors, wherein the method comprises writing redundancy information of the current tensor in at least one preceding or following packet of the bitstream different from the current packet, and/or writing, in the current packet, redundancy information of at least one tensor to be written in at least one preceding or following packet of the bitstream different from the current packet.

Another embodiment may have a non-transitory digital storage medium having a computer program stored thereon to perform the method comprising: generating, through at least one learnable layer, an audio signal representation as a representation of an audio signal, the audio signal representation comprising a sequence of tensors; converting each current tensor of the sequence of tensors onto at least one index, wherein each index is obtained from at least one codebook associating a plurality of tensors to a plurality of indexes; writing packets in a bitstream, so that a current packet comprises the at least one index for the current tensor of the sequence of tensors, wherein the method comprises writing redundancy information of the current tensor in at least one preceding or following packet of the bitstream different from the current packet, and/or writing, in the current packet, redundancy information of at least one tensor to be written in at least one preceding or following packet of the bitstream different from the current packet, when said computer program is run by a computer.

According to the invention, there is provided an audio signal representation decoder configured to decode an audio signal representation from a bitstream, the bitstream being divided in a sequence of packets, the audio signal representation decoder comprising:
a bitstream reader, configured to sequentially read the sequence of packets;
a packet loss controller, configured to check whether a current packet is well received or is to be considered as lost;
a quantization index converter, configured, in case the packet loss controller has determined that the current packet is well received, to convert at least one index extracted from the current packet onto at least one current code from at least one codebook, thereby forming at least one portion of the audio signal representation; and
wherein the audio signal representation decoder is configured, in case the packet loss controller has determined that the current packet is to be considered as lost, to generate, through at least one learnable predictor layer, at least one current code by from at least one preceding code or, thereby forming at least one portion of the audio signal representation.

According to an aspect, the at least one codebook associates indexes to codes or parts of codes, so that the quantization index converter converts the at least one index extracted from the current packet onto the at least one converted code, or at least one part of a converted code.

According to an aspect, the at least one codebook includes:
a base codebook associating indexes to main portions of codes; and
at least one low-ranking codebook associating indexes to residual portions of codes,
wherein the at least one index extracted from the current packet includes at least one high-ranking index and at least one low-ranking index,
wherein the quantization index converter is configured to convert the at least one high-ranking index onto a main portion of the current code, and the at least one low-ranking index onto at least one residual portion of the current code,
wherein the quantization index converter is further configured to reconstruct the current code by adding the main portion to the at least one residual portion.

According to an aspect, the at least one codebook includes:
a base codebook associating indexes to main portions of codes; and
at least one low-ranking codebook,
wherein the at least one index extracted from the current packet includes at least one high-ranking index and at least one low-ranking index,
wherein the quantization index converter is configured to convert the at least one high-ranking index onto a main portion of the current code, or a high-ranking subcode, and the at least one low-ranking index onto at least one residual portion of the current code, or a high-ranking subcode,
wherein the quantization index converter is further configured to reconstruct the current code by adding the main portion to the at least one residual portion or by putting together the at least one high-ranking subcode with the at least one low-ranking subcode or by putting together the at least one high-ranking subcode with the at least one low-ranking subcode or by putting together the high-ranking subcode with the at least one low-ranking subcode.

According to an aspect, the audio signal representation decoder may be configured to predict at least one current code from at least the at least one high-ranking index of the at least one preceding or following packet, but not from the lowest-ranking index of the at least one preceding or following packet.

According to an aspect, the audio signal representation decoder may be configured to predict the current code from at least the high-ranking index of the at least one preceding packet and from at least one middle-ranking index, but not from the lowest-ranking index of the of the at least one preceding packet.

According to an aspect, the audio signal representation decoder may be configured to store redundancy information written in packets of the bitstream but referring to different packets, the audio signal representation decoder being configured to store the redundancy information in a temporary storage unit,
wherein the audio signal representation decoder is configured, in case the at least one current packet is to be considered as lost, to search the temporary storage unit, and, in case the redundancy information referring to the at least one current packet is retrieved, to:
retrieve at least one index from the redundancy information referring to the current packet;
cause the quantization index converter to convert the at least one retrieved index from the at least one codebook onto a substitutive code;
cause the processing block to generate the at least one portion of the audio signal by converting the at least one substitutive code onto the at least portion of the audio signal.

According to an aspect, the redundancy information provides at least the high-ranking index(es) of the at least one preceding or following packet, but not at least one of the lower-ranking index(es) of the at least one preceding or following packet.

According to an aspect, at least one learnable predictor may be configured to perform the prediction, the at least one learnable predictor having at least one learnable predictor layer.

According to an aspect, the at least one learnable predictor is trained by sequentially predicting predicted current codes, or respectively current indexes, from preceding and/or following packets, and by comparing the predicted current codes, or the current codes obtained from predicted indexes, with converted codes converted from packets having been well received, so as to learn learnable parameters of the at least one learnable predictor layer which minimize errors of the predicted current codes with respect the converted codes converted from the packets having correct format.

According to an aspect, the at least one learnable predictor layer includes at least one recurrent learnable layer.

According to an aspect, the at least one learnable predictor layer includes at least one gated recurrent unit.

According to an aspect, the at least one learnable predictor layer has at least one state,
the at least one learnable predictor layer being iteratively instantiated, along a sequential plurality of learnable predictor layer instantiations,
in such a way that, to predict the current code, a current learnable predictor layer instantiation receives a state from at least one preceding learnable predictor layer instantiation which has predicted at least one preceding code for at least one preceding packet.

According to an aspect, to predict the current code, the current learnable predictor layer instantiation receives in input:
the at least one preceding converted code in case the at least one preceding packet is considered well received; and
the at least one preceding predicted code in case the at least one preceding packet is considered as lost.

According to an aspect, to predict the current code, the current learnable predictor layer instantiation receives the state from the at least one preceding iteration both in case the at least one preceding packet is considered well received and in case the at least one preceding packet is considered as lost.

According to an aspect, the at least one learnable predictor layer is configured to predict the current code and/or to receive the state from the at least one preceding learnable predictor layer instantiation both in case the at least one preceding packet is considered well received and in case the at least one preceding packet is considered as lost, so as to provide the predicted code and/or to output the state to at least one subsequent learnable predictor layer instantiation.

According to an aspect, the current learnable predictor layer instantiation includes at least one learnable convolutional unit.

According to an aspect, the current learnable predictor layer instantiation includes at least one learnable recurrent unit.

According to an aspect, the at least one recurrent unit of the current learnable layer is inputted with a state from a correspondent at least one recurrent unit from the at least one preceding learnable predictor layer instantiation, and outputs a state to a corresponding at least one recurrent unit of at least one subsequent learnable predictor layer instantiation.

According to an aspect, the current learnable predictor layer instantiation has a series of learnable layers.

According to an aspect, for the current learnable predictor layer instantiation, the series of learnable layers includes at least one dimension-reducing learnable layer and at least one dimension-increasing learnable layer subsequent to the at least one dimension-reducing learnable layer.

According to an aspect, the at least one dimension-reducing learnable layer includes at least one learnable layer with a state.

According to an aspect, the at least one dimension-increasing learnable layer includes at least one learnable layer without a state.

According to an aspect, the series of learnable layers is gated.

According to an aspect, the series of learnable layers is gated through a softmax activation function.

According to the invention, there is provided an audio signal representation decoder configured to decode an audio signal representation from a bitstream, the bitstream being divided in a sequence of packets, the audio signal representation decoder comprising:
a bitstream reader, configured to sequentially read the sequence of packets, and to extract, from the at least one current packet:
   at least one index of the at least one current packet;
   redundancy information on at least one preceding or following packet, the redundancy information permitting to reconstruct at least one index within the at least one preceding or following packet;
a packet loss controller, PLC, configured to check whether the at least one current packet is well received or is to be considered as lost;
a quantization index converter, configured, to convert the at least one index of the at least one current packet onto at least one current converted code from at least one codebook, thereby forming a portion of the audio signal representation;
a redundancy information storage unit, configured to store the redundancy information and to provide the stored redundancy information on the at least one current packet in case the PLC has determined that the at least one current packet is to be considered as lost, to form a portion of the audio signal representation through the redundancy information.

According to an aspect, the redundancy information storage unit is configured to store, as redundancy information, at least one index from a preceding or following packet, so as to provide, to the quantization index converter, the stored at least one index in case the controller has determined that the at least one current packet is to be considered as lost.

According to an aspect, the redundancy information storage unit is configured to store, as redundancy information, at least one code previously extracted from a preceding or following packet, to bypass the quantization index converter using the stored code in case in case the controller has determined that the at least one current packet is to be considered as lost.

According to an aspect, the at least one codebook associates indexes to codes or parts of codes, so that the quantization index converter converts the at least one index extracted from the current packet onto the at least one converted code, or at least one part of a converted code.

According to an aspect, the at least one codebook includes:
a base codebook associating indexes to main portions of codes; and
at least one low-ranking codebook associating indexes to residual portions of codes,
wherein the at least one index extracted from the current packet includes at least one high-ranking index and at least one low-ranking index,
wherein the quantization index converter is configured to convert the at least one high-ranking index onto a main portion of the current code, and the at least one low-ranking index onto at least one residual portion of the current code,
wherein the quantization index converter is further configured to reconstruct the current code by adding the main portion to the at least one residual portion.

According to an aspect, an audio signal representation decoder may be configured to generate or retrieve the at least one current code from at least the at least one high-ranking index of the at least one preceding or following packet, but not from the lowest-ranking index of the of the at least one preceding or following packet.

According to an aspect, an audio signal representation decoder may be configured to generate or retrieve the current code from at least the high-ranking index of the at least one preceding or following packet and from at least one middle-ranking index, but not from the lowest-ranking index of the of the at least one preceding or following packet.

According to the invention, there is provided an audio generator for generating an audio signal from a bitstream, comprising the audio signal representation decoder,
further configured to generate the audio signal by converting the audio signal representation onto the audio signal.

According to an aspect, the audio signal may be further configured to render the generated audio signal.

According to an aspect, a first data provisioner may be configured to provide, for a given frame (e.g. a portion of audio signal to be generated), first data derived from an input signal. There may be a first processing block, configured, for the given frame, to receive the first data and to output first output data in the given frame,
wherein the first processing block comprises:
   at least one conditioning learnable layer configured, for the given frame, to process target data, from the decoded audio signal representation, to obtain conditioning feature parameters for the given frame; and
   a styling element, configured to apply the conditioning feature parameters to the first data or normalized first data.

According to an aspect, the audio generator may be configured so that the bitrate of the audio signal is greater than the bitrate of both the target data and/or of the first data and/or of the second data.

According to an aspect, the second processing block may be configured to increase the bitrate of the second data, to obtain the audio signal.

According to an aspect, the first processing block is configured to up-sample the first data from a number of samples for the given frame to a second number of samples for the given frame greater than the first number of samples.

According to an aspect, the second processing block is configured to up-sample the second data obtained from the first processing block from a second number of samples for the given frame to a third number of samples for the given frame greater than the second number of samples.

According to an aspect, the audio generator may be configured to reduce the number of channels of the first data from a first number of channels to a second number of channels of the first output data which is lower than the first number of channels.

According to an aspect, the second processing block may be configured to reduce the number of channels of the first output data, obtained from the first processing block, from a second number of channels to a third number of channels of the audio signal, wherein the third number of channels is lower than the second number of channels.

According to an aspect, the audio signal is a mono audio signal.

According to an aspect, the audio generator may be configured to obtain the input signal from the audio signal representation.

According to an aspect, the audio generator may be configured to obtain the input signal from noise.

According to an aspect, the conditioning set of learnable layers comprises one or at least two convolution layers.

According to an aspect, at least one preconditioning learnable layer configured to receive the audio signal representation, or a processed version thereof, and, for the given frame, output target data representing the audio signal in the given frame.

According to an aspect, the at least one preconditioning learnable layer is configured to provide the target data as a spectrogram or a decoded spectrogram.

According to an aspect, a first convolution layer is configured to convolute the target data or up-sampled target data to obtain first convoluted data using a first activation function.

According to an aspect, the conditioning set of learnable layers and the styling element are part of a weight layer in a residual block of a neural network comprising one or more residual blocks.

According to an aspect, the audio generator further comprises a normalizing element, which is configured to normalize the first data.

According to an aspect, the audio generator further comprises a normalizing element, which is configured to normalize the first data in the channel dimension.

According to an aspect, the audio signal is a voice audio signal.

According to an aspect, the target data is up-sampled by a factor of a power of 2 or by another factor, such as 2.5 or a multiple of 2.5.

According to an aspect, the target data is up-sampled by non-linear interpolation.

According to an aspect, the first processing block further comprises:
a further set of learnable layers, configured to process data derived from the first data using a second activation function,
wherein the second activation function is a gated activation function.

According to an aspect, the further set of learnable layers comprises one or two or more convolution layers.

According to an aspect, the second activation function is a softmax-gated hyperbolic tangent, TanH, function.

According to an aspect, the first activation function is a leaky rectified linear unit, leaky ReLu, function.

According to an aspect, convolution operations run with maximum dilation factor of 2.

According to an aspect, an audio generator comprises eight first processing blocks and one second processing block.

According to an aspect, the first data has one dimension, which is lower than the audio signal.

According to an aspect, the target data is a spectrogram.

According to an aspect, there is provided an encoder, comprising:
an audio signal representation generator configured to generate, through at least one learnable layer, an audio signal representation as a representation of an audio signal, the audio signal representation including a sequence of tensors;
a quantizer configured to convert each current tensor of the sequence of tensors onto at least one index, wherein each index is obtained from at least one codebook associating a plurality of tensors to a plurality of indexes;
a bitstream writer configured to write packets in the bitstream, so that a current packet includes the at least one index for the current tensor of the sequence of tensors,
wherein the encoder is configured to write redundancy information of the current tensor in at least one preceding or following packet of the bitstream different from the current packet and/or to write, in the current packet, redundancy information of a tensor, different from the current tensor, in the current packet

According to an aspect, the at least one codebook associates parts of tensors to indexes, so that the quantizer converts the current tensor onto a plurality of indexes.

According to an aspect, the at least one codebook includes:
a base codebook associating main portions of tensors to indexes; and
at least one low-ranking codebook associating residual portions of tensors to indexes,
wherein the at least one current tensor has at least one main portion and at least one residual portion,
wherein the quantizer is configured to convert the main portion of the at least one current tensor onto at least one high-ranking index, and the at least one residual portion of the at least one tensor onto at least one low-ranking index,
so that the bitstream writer writes, in the bitstream, both the high-ranking index and the at least one low-ranking index.

According to an aspect, the encoder may be configured to provide the redundancy information with at least the high-ranking index(es) of the at least one preceding or following packet, but not at least the lowest-ranking low-ranking index(es) of the same at least one preceding or following packet.

According to an aspect, the encoder may be configured to transmit the bitstream to a receiver through a communication channel.

According to an aspect, the encoder may be configured to monitor the payload state of the communication channel, so as, in case the payload state in the communication channel is over a predetermined threshold, to increase the quantity of redundancy information.

According to an aspect, the encoder may be configured to:
in case the payload in the communication channel is below the predetermined threshold, to only transmit, as redundancy information, for each current packet, high-ranking indexes of the at least one preceding or following packet; and
in case the payload of the communication channel is over the predetermined threshold, to transmit, as redundancy information, for each current packet, both the high-ranking indexes of the at least one preceding or following packet and at least some low-ranking indexes of the same at least one preceding or following packet.

According to an aspect, the encoder may be configured to compute a packet offset between the current packet and the at least one preceding or following packet having the redundant information at least in function of the payload of the communication channel.

According to an aspect, the encoder may be configured to compute a packet offset between the current packet and the at least one preceding or following packet having the redundant information at least in function of the envisioned application.

According to an aspect, the encoder may be configured to compute a packet offset between the current packet and the at least one preceding or following packet having the redundant information at least in function of an input provided by the end-user.

According to an aspect, the at least one codebook includes a redundancy codebook associating a plurality of tensors to a plurality of indexes, wherein the encoder is configured to write the redundancy information of the current tensor in the at least one preceding or following packet of the bitstream different from the current packet as an index received from the at least one quantization codebook.

According to an aspect, there is provided a method for decoding an audio signal representation from a bitstream, the method including:
reading a sequence of packets comprised in the bitstream, and extracting, from a current packet:
   at least one index of the current packet;
   redundancy information on at least one preceding or following packet, the redundancy information permitting to reconstruct at least one index within the at least one preceding or following packet;
checking whether the current packet is well received or is to be considered as lost;
converting the at least one index of the current packet onto at least one current converted code from at least one codebook, thereby forming a portion of the audio signal representation;
storing the redundancy information and providing the stored redundancy information on the at least one current packet in case the checking has determined that the at least one current packet is to be considered as lost, to form a portion of the audio signal representation through the redundancy information.

According to an aspect, there is provided a method for decoding an audio signal representation from a bitstream, the bitstream being divided in a sequence of packets, the audio signal representation decoder comprising:
sequentially reading the sequence of packets;
checking whether a current packet is well received or is to be considered as lost;
in case the checking has determined that the current packet is well received, converting at least one index extracted from the current packet onto at least one current code from at least one code-book, thereby forming at least one portion of the audio signal representation; and
in case the packet loss controller has determined that the current packet is to be considered as lost, generating, through at least one learnable predictor layer, at least one current code by prediction from at least one preceding code or index.

According to an aspect, there is provided a method comprising:
generating, through at least one learnable layer, an audio signal representation as a representation of an audio signal, the audio signal representation including a sequence of tensors;
converting each current tensor of the sequence of tensors onto at least one index, wherein each index is obtained from at least one codebook associating a plurality of tensors to a plurality of indexes;
writing packets in a bitstream, so that a current packet includes the at least one index for the current tensor of the sequence of tensors,
wherein the method includes writing redundancy information of the current tensor in at least one preceding or following packet of the bitstream different from the current packet, and/or writing, in the current packet, redundancy information of at least one tensor to be written in at least one preceding or following packet of the bitstream different from the current packet.

According to an aspect, there is provided a non-transitory storage unit storing instructions which, when executed by a computer, cause the computer to:
extract, from a current packet:
   at least one index of the current packet; and
   redundancy information on at least one preceding or following packet, the redundancy information permitting to reconstruct at least one index within the at least one preceding or following packet;
check whether the current packet is well received or is to be considered as lost;
convert the at least one index of the current packet onto at least one current converted code from at least one codebook, thereby forming a portion of the audio signal representation;
control the storing of the redundancy information and retrieved the stored redundancy information on the at least one current packet in case the checking has determined that the at least one current packet is to be considered as lost, to form a portion of the audio signal representation through the redundancy information.

According to an aspect, there is provided a non-transitory storage unit storing instructions which, when executed by a computer, cause the computer to:
sequentially read a sequence of packets;
check whether a current packet is well received or is to be considered as lost;
in case the check has determined that the current packet is well received, convert at least one index extracted from the current packet onto at least one current code from at least one code-book, thereby forming at least one portion of the audio signal representation; and
in case the check has determined that the current packet is to be considered as lost, generate, through at least one learnable predictor layer, at least one current code by prediction from at least one preceding code or index.

According to an aspect, there is provided a non-transitory storage unit storing instructions which, when executed by a computer, cause the computer to:
generate, through at least one learnable layer, an audio signal representation as a representation of an audio signal, the audio signal representation including a sequence of tensors;
convert each current tensor of the sequence of tensors onto at least one index, wherein each index is obtained from at least one codebook associating a plurality of tensors to a plurality of indexes;
write packets in a bitstream, so that a current packet includes the at least one index for the current tensor of the sequence of tensors,
write redundancy information of the current tensor in at least one preceding or following packet of the bitstream different from the current packet, and/or writing, in the current packet, redundancy information of at least one tensor to be written in at least one preceding or following packet of the bitstream different from the current packet.

In aspects above, it is often referred to portions of codes. For example, they may refer to components (e.g. addends) or subcodes (e.g. high-ranking subcodes and low-ranking subcodes).

### BRIEF DESCRIPTION OF THE DRAWINGS

Embodiments of the present invention will be detailed subsequently referring to the appended drawings, in which:

FIGS. 1a and 1b show examples according to the present disclosure for PLC.

FIG. 2 shows a technique at an audio signal representation decoder.

FIGS. 3a and 3b show bitstream buffering techniques

FIGS. 4 and 5 show evaluation results of present examples.

FIGS. 6a and 6b show examples of audio encoders and of audio signal representation encoders.

FIGS. 7, 8a, and 8b show examples of audio decoders and of audio signal representation decoders.

FIGS. 9-13 shows examples of audio decoders and of techniques for audio decoders and audio signal representation decoders.

### DETAILED DESCRIPTION OF THE INVENTION

It is noted that, here below, reference is often made to learnable layers. These learnable layers may be implemented, for example, in neural networks.

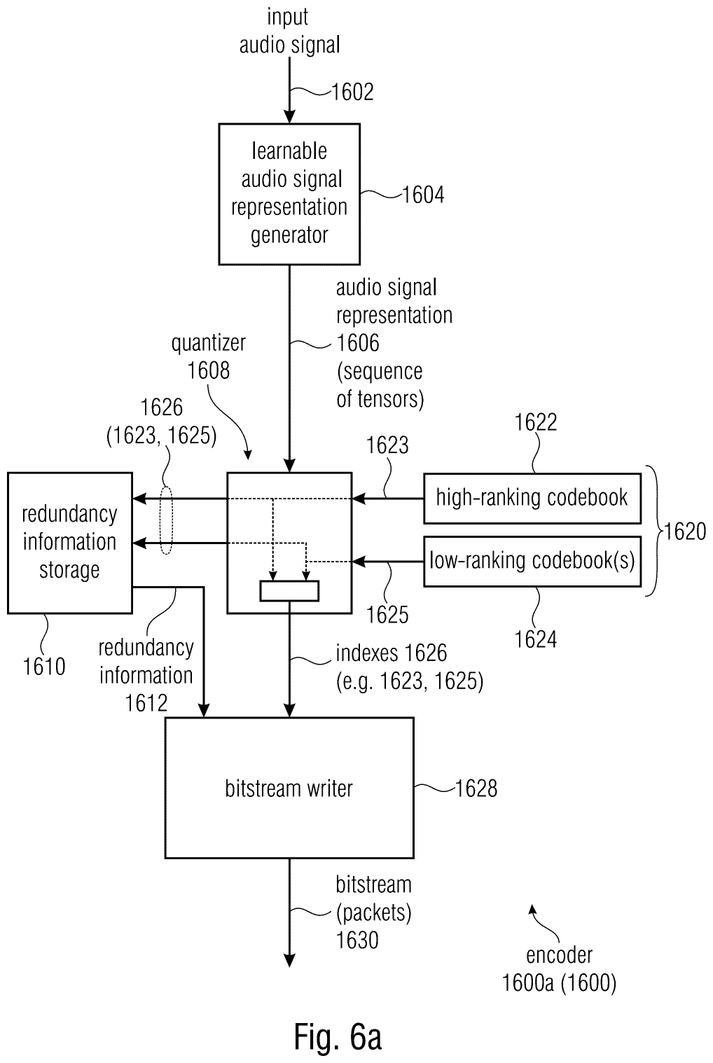

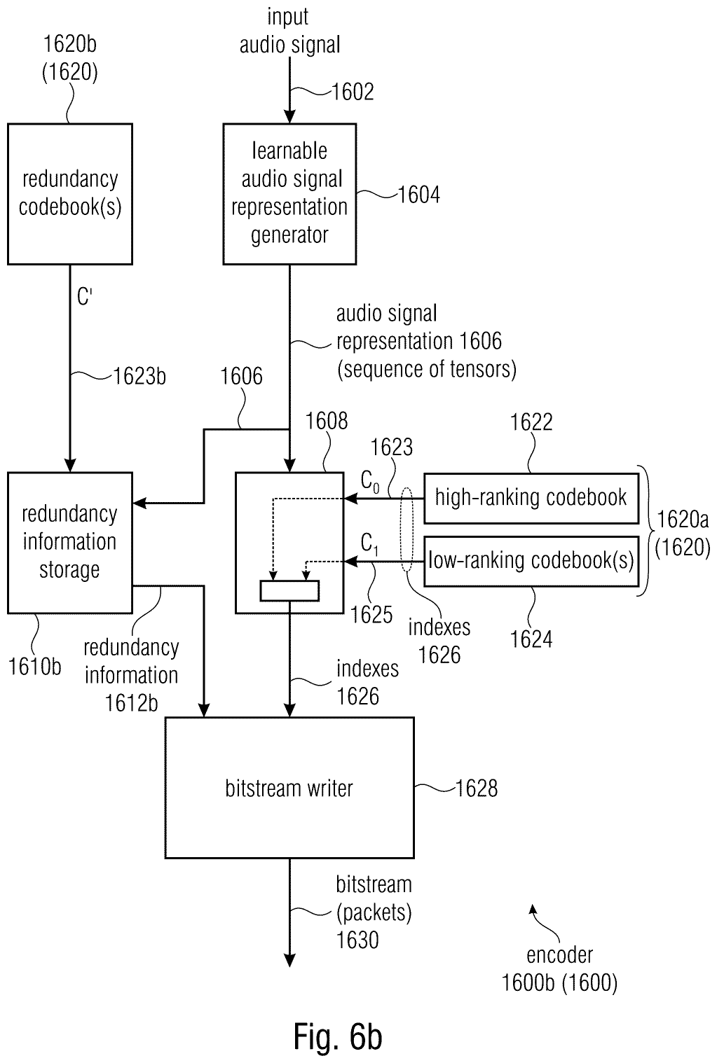

FIGS. 6a and 6b show two examples of an encoder 1600, in particular, an encoder 1600a in FIG. 6a and an encoder 1600b in FIG. 6b.

With reference to FIG. 6a, the encoder 1600a of FIG. 6a encodes an input audio signal 1602 onto a bitstream 1630. The input audio signal 1602 may be an uncompressed analog or digital representation of an audio signal, e.g. recorded from a microphone and/or stored in a storage unit and/or received from remote. The encoder 1600a may operate sequentially, e.g. by sequentially generating a packet (or a portion of packet, or a plurality of packets) of the bitstream from one portion of the input audio signal 1602. The encoder 1600a may comprise an audio signal representation generator 1604. The audio signal representation generator 1604 may comprise at least one learnable layer, and may therefore be considered a learnable audio signal representation generator 1604. The audio signal representation generator 1604 may generate (e.g., through the at least one learnable layer) an audio signal representation 1606, which may be a sequence of tensors (codes). Each tensor may be a vector or a matrix, or a generalized matrix (e.g. having more than 2 dimensions, e.g. a n×m×p tensor wherein at least one of n, m, and p is greater than 1). In case the tensor is a vector, it shall at least have two dimensions (e.g. a n×1 matrix, with n greater than 1).

The encoder 1600a may include a quantizer 1608. The quantizer 1608 may convert each current tensor 1606 of the sequence of tensors onto at least one index 1626. Therefore, a sequence of indexes may be outputted by the quantizer 1608.

Each index may be received from at least one codebook. The at least one codebook is collectively indicated, in FIG. 6a, with the reference numeral 1620. In general terms, the quantizer 1608 may search, in the at least one codebook 1620, an index which shall represent a particular code (or a portion thereof) in the bitstream 1630.

In some examples, there may be several codebooks. FIG. 6a shows a high-ranking codebook 1622. The high-ranking codebook may output, to the quantizer 1608, at least one high-ranking index 1623. FIG. 6a also shows a low-ranking codebook 1624 (which may be optional), which may output low-ranking indexes 1625 to the quantizer 1608. This is because, in some examples, it is possible to associate multiple indexes to one tensor, to increase resolution: the higher ranking index 1623 will be awarded to the most significant portion of the tensor 1606; a lower ranking index 1625 will be awarded to a less significant portion of the tensor 1606; and so on, up to the lowest ranking index, awarded to the least significant portion of the tensor 1606. Hence, there may be more than one low-ranking codebook (and, in this case, there can be a ranking between different codebooks, so that each codebook has a ranking that is different from the other codebooks; there may be a base codebook which is the highest ranking codebook, and low-ranking codebooks). In some examples, there are three codebooks (e.g. base codebook which is the highest ranking codebook, a middle-ranking codebook, and a lowest-ranking codebook). In other examples, there can be four codebooks (e.g. base codebook which is the highest ranking codebook, a first-highest-ranking codebook, a second-highest-ranking codebook, and a lowest-ranking codebook). The indexes outputted by the base codebook are the highest-ranking indexes, the indexes outputted by the lowest-ranking codebook are the lowest-ranking indexes, and so on. However, in some examples, there may be one single codebook 1620 (and no low-ranking codebook 1624 may therefore be present). In any case, each codebook 1620 (whether alone, or whether there are multiple codebooks 1622, 1624, etc.) provides an index 1626 for each tensor or part of tensors. Therefore, each tensor 1606 is mapped onto one index 1626 (e.g., in some cases when there is only one codebook and there are no low-ranking codebooks 1624), or each tensor 1606 may be mapped onto multiple indexes 1626 (e.g., 1623, 1625), e.g. where there are multiple codebooks (e.g., 1622, 1624, etc.). For each tensor inputted into the quantizer 1608, the outputted indexes 1626 may be recognized, for example, by their position.

The quantizer 1608 when using several codebooks can involve techniques known as split vector quantization and multi-stage vector quantization, also known as residual vector quantization. In split vector quantization, the tensor to quantize is split into multiple subvectors (or more in general subtensors), which are then quantized independently. This allows for a more fine-grained control over the quantization process, as different subvectors (or more in general subtensors) can be quantized using different bit widths or precision levels. Split vector quantization design can be performed manually, by selecting the optimal bit width for each subvector (or more in general subtensors), or automatically, using machine learning techniques. In contrast, multi-stage vector quantization involves quantizing the tensor from lower to higher precision representations in iterative multiple stages, with each stage decreasing the quantization distortion further. It is achieved as described above by coding first the tensor with the highest ranking codebook and coding the resulting quantization error further by second highest ranking codebooks. The process is repeated till the last stage with the lowest ranking codebook. Once again, the quantization design can be done manually, by selecting the optimal bit width for each stage, or automatically, using machine learning techniques.

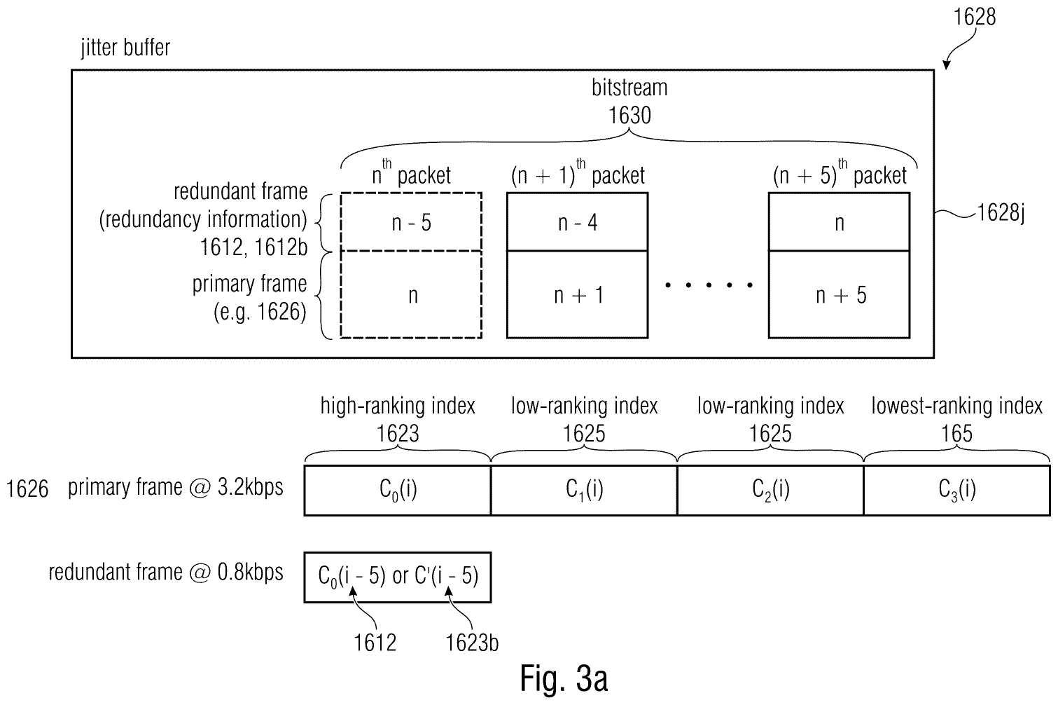

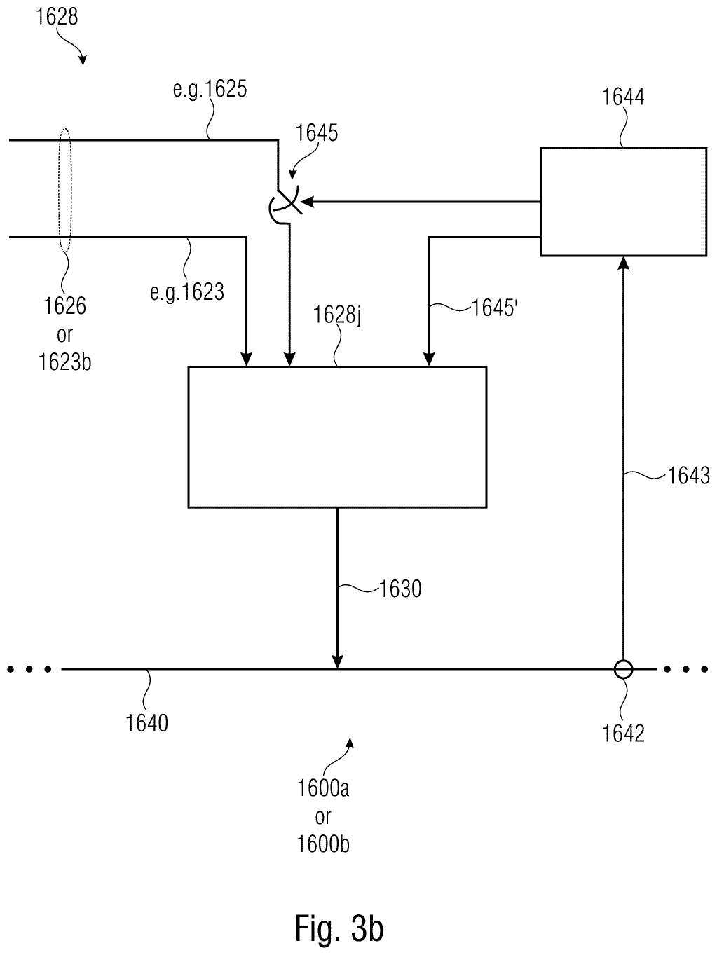

The encoder 1600a may include a bitstream writer 1628. The bitstream writer 1628 may write packets in the bitstream 1630. For example, the indexes 1626 (e.g., 1623, 1625) may be encapsulated in a current packet according to a predetermined syntax and/or in a predetermined position. As will be shown in FIG. 3a (see below), a packet may comprise one primary frame (which may be a primary frame, carrying indexes 1626 written by the quantizer 1608 based on the at least one codebook) and one secondary frame (which may carry redundancy information 1612 or 1612b, as explain below). Therefore, the encoder 1600a may write redundancy information 1612 of the current sensor 1606 in the bitstream 1630. Notably, however, the redundancy information 1612 may be written in at least one preceding or following packet of the bitstream 1630, which is different from the current packet. Analogously, in the preceding or following packets of the bitstream, there may be redundancy information of even other packets.

Further, the current packet may be associated (e.g. in the same fame) with redundancy information of a different packet. The bitstream 1630 may comprise, for each packet, also further information such as a packet identifier, and syntactical redundancy check information (e.g., cyclic redundancy check, CRC, information, or other syntactical redundancy check information, such as parity/disparity bit, or others), which will help the receiver to determine between the packet being considered correctly received (and will therefore be used for rendering audio signal) or the packet being to be considered as lost (and will therefore be used for rendering audio signal). Advantageously, however, even if a packet will be considered as lost by the receiver, notwithstanding there will be redundancy information in at least one other packet which will permit to reconstruct, at least partially, the portion of the audio signal.

According to an example, the redundancy information 1612 may be outputted by a redundancy information storage 1610, e.g. to be provided to the bitstream writer 1628. The redundancy information storage 1610 may store indexes 1626 (e.g., 1623, 1625) relating to the current tensor 1606, and provide the indexes to the bitstream writer 1628, in a packet different from the current packet. It is noted that in FIG. 6a it is shown that both the high-ranking indexes 1623 (received from the high-ranking codebook 1622) and the low-ranking indexes 1625 (received from the low-ranking codebook 1624) are provided to the redundancy information storage 1610. Notwithstanding, in some examples, only the high-ranking codebooks 1623 are provided to the redundancy information storage 1610, while it is refrained from providing the low-ranking codebooks 1625 to the redundancy information storage 1610: in this case, a result is that the low-ranking codebook 1625 will not participate to the redundancy information 1612 to be written in the bitstream 1630. In the examples in which there are more than two codebooks (e.g., the high-ranking, base codebook, a middle-ranking codebook, a low-ranking codebook with ranking lower than the base codebook, and so on) it may be that only indexes from higher-ranking codebooks are provided to the redundancy information storage 1612, while at least one low-ranking codebook provides indexes that are not provided to the redundancy information storage. In some examples, also at least some (e.g. all) of the at least one low-ranking indexes are provided to the redundancy information storage 1610, but it is dynamically decided whether to also provide the low-ranking indexes to the bitstream writer 1628 based on the payload state of the network (e.g. in such a way that, if the network is busy over a predetermined threshold, then at least some of the lower-ranking indexes are not written in the bitstream 1630, while if the network is busy over a predetermined threshold, also the lower-ranking indexes are written in the bitstream 1630; see also below).

Therefore, each codebook 1620 (1622, 1624, etc.) may associate parts of tensors to indexes, so that the quantizer 1608 converts the current tensor 1606 onto a plurality of indexes.

As explained above, each codebook 1620 (1622, 1624, etc.) may include (in some examples) a base codebook (high-ranking codebook) 1622 which associates main portions of tensors to indexes, and at least one low-ranking codebook 1624 associated to residual portions of tensors to indexes. This is because each tensor may have at least one main portion and at least one residual portion (the residual portion may be more than one, and may be ranked exactly as the codebooks). Therefore, the quantizer 1608 may convert the main portion of at least one current tensor onto at least one high-ranking index 1623, and the at least one residual portion of the at least one tensor onto at least one low-ranking index 1625. Accordingly, the bitstream writer 1628 may write, in the bitstream 1620, both the high-ranking index and the at least one low-ranking index 1625. As explained above, in some examples, only at least one high-ranking index 1623 (obtained from the high-ranking codebook 1622) of the at least one preceding or following packet is written in the bitstream, while at least the lowest-ranking index 1625 (or, in some examples, other low-ranking indexes with a ranking intermediate between the highest-ranking codebook and the lowest-ranking codebook) are not written in the bitstream 1630.

In the encoder 1600b of FIG. 6b, the learnable audio signal representation generator 1604 can be the same of that of the encoder 1600a of FIG. 6a. Also, the bitstream writer 1628 may be, in principle, not different from the analogous bitstream writer of the encoder 1600a of FIG. 6a. There may be at least one codebook 1620a (e.g. 1622, 1624), which may be, in principle, the same of the be at least one codebook 1620 (e.g. 1622, 1624) of the encoder 1600a of FIG. 6a. However, in the encoder 1600b the redundancy information (here indicated with 1612b) may be obtained from indexes 1623b derived from at least one codebook 1620b (“redundancy codebook”) different from the codebook 1620a. The index 1623b provided by the codebook 1620b may be a codebook with restricted resolution and with reduced length (therefore reducing the payload, and speeding up the transmission). Basically, the codebook 1620b is in general different from the main codebook 1620a (1622, 1624) outputting the indexes 1626 (e.g., 1623, 1625, etc.) to the quantizer 1608. The indexes 1623b provided by the redundancy codebook 1620b may, advantageously, have a worse resolution than the indexes 1626 (e.g., 1623, 1625, etc.) provided by the at least one codebook 1620a (e.g., 1622, 1624, etc.). The at least one codebook 1620a may, therefore, be considered an at least one main codebook, while the at least one redundancy codebook 1620b (which may have a worse resolution) may provide approximated information with respect to the indexes 1626 (e.g., 1623, 1625, etc.) provided in the bitstream 1630. Therefore, the redundancy codebook 1620b may provide indexes 1623b, which occupy less bit length than the indexes outputted by the main codebook 1620a. Further the redundancy codebook can be designed and trained for the specific size and need of the redundancy information storage, which will lead to better redundant information 1612b than retaining part the indexes derived from the quantizer 1608. Apart from that, the at least one codebook 1620b (and the indexes 1623b) may have the same design of the at least one main codebook 1620a. For example, there may be one high-ranking redundancy codebook and at least one low-ranking redundancy codebook, and there can be different approximations, etc. Therefore, the fact that the arrow 1623b is a single arrow does not necessarily imply that there is only one single index 1623b outputted by the redundancy codebook 1620b. Hence, the redundancy codebook 1620b can be described in the same way, in any aspect, as the ranking codebook 1620a. Therefore, any feature described for the at least one codebook 1620 (1622, 1624) or 1624a in principle may be also used to describe any example of the redundancy codebook 1610, and its description is not repeated for the sake of conciseness.

FIG. 3a shows an example of encapsulating both the indexes 1626 as converted by the quantizer 1608 and the redundancy information 1612 or 1612b for any of the encoders 1600a and 1600b. The redundancy information 1612 or 1612b may be generated by the bitstream writer 1628 e.g. in a jitter buffer 1628j. The bitstream writer 1628 (e.g., the jitter buffer 1628j) may therefore generate a packet in a primary frame (which may contain the index(es) 1626 as outputted by the quantizer 1608) and a redundant frame (which may contain the redundancy information 1612 or 1612b). In the figure, an n^{th} packet is shown having a primary frame n and a redundant frame n−5; an (n+1)^{th} packet having the (n+1)^{th} primary frame and the (n−4)^{th} redundant frame (which is also redundancy information 1612 or 1612b), and up to an (n+5)^{th} primary frame and an n^{th} redundancy frame. Basically, in the (n+5)^{th} packet, the redundancy information is taken from the n^{th} packet (e.g., in a reduced version) such as only the high-ranking indexes 1623 but not the low-ranking indexes 1625. Therefore, when the n^{th} packet is encoded by the bitstream writer 1628 information on the primary frame n is provided to the redundancy information storage 1610 (in the case of the encoder 1600a of FIG. 6a) to be subsequently used, as a redundancy information 1612, for encoding the (n+5)^{th} packet. In other cases, there may be the example of the FIG. 6b, when the n+5 is encoded the redundancy information for the n^{th} packet (redundancy information 1612b) is taken from a different codebook with respect to a redundancy codebook 1620b which is different from the main codebook 1620. It is also noted that the primary frame 1626 is shown to comprise indexes C₀(i), C₁(i), C₂(i), C₃(i) for the i^{th} frame (C₀ is the index 1623 obtained from the high-ranking codebook 1622, C₁ is a first low-ranking index 1625 obtained from the low-ranking codebook 1624, and so on). The redundant frame C₀(i−5) (1612) may be substituted by C′(i−5) in the case of the example of FIG. 6b.

As explained above, in other cases the bitstream 1630 may be transmitted to a receiver. FIG. 3b shows an example of a technique which may be implemented in the encoder 1600a or 1600b. In the cases in which the bitstream 1630 is transmitted in a network 1640, or more in general in a communication channel. Here, the quantity of redundancy information to be written in the current packet can vary based on the state of the network 1640. FIG. 3b shows a detector 1642 which may detect the state of the network 1640 (the detector may measure, for example, the latency of the transmission, e.g. as provided in acknowledgment from the receiver, and/or may measure the quantity of transmissions concurrently transmitted by other devices, and/or may have knowledge on the corrupted frames as acknowledged by the receiver, or detect or sense any other metrics which permits to determine the state of the communication channel). A controller 1644 may read the state 1643 of the network 1640. As can be seen, the controller 1644 is shown to control a switch 1645 which can select between permitting and preventing the encoding of at least one low-ranking index 1625, but which has no influence on the encoding of the high-ranking index 1625. The switch 1624 may be opened, for example, when the payload state of the network 1640 is below a predetermined threshold, so that there is not the encoding of the low-ranking index 1625 when the network is busy, while the at least one high-ranking index 1623 is notwithstanding written in the bitstream 1630. In case the payload state of the network (communication channel) 1640 is below the predetermined threshold (meaning that the network is comparatively free), then the switch 1645 is closed and the low-ranking index 1625 may be written in the bitstream 1630.

In addition or in alternative, the controller 1644 may exert a control 1645′, based on the payload status 1643 of the communication channel 1640, to control the offset between the current packet and the packet from which the redundancy information 1612 or 1612b is received. Accordingly, the offset between the currently written packet and the packet for which the redundancy information is provided can dynamically vary according to the payload. With reference to FIG. 3a, there may be the situation in which instead of the (n−5)^{th} packet the (n−4)^{th} is encoded as redundancy information, thereby changing the offset dynamically with the payload. In another situation, the control 1645′ may be not based (or not completely based) on the payload 1643 of the network 1640, but on a selection from a user or by a preselection. As an example, if network is congested, packet drop rate is higher, and offset may need to be increased if it implies larger bursts of packet lost. Alternatively, one can add another layer of redundancy information by within a signal nth packet add 2 redundancy information with 2 different offset. For example nth packet can be attached with (n−5)th redundancy information and (n−7)th redundancy information. It will then protect even more the bitstream at a cost of any additional extra bit-rate.

Therefore, the encoder may compute a packet offset between the current packet and the at least one preceding or following packet having the redundant information at least in function of the payload of the communication channel, e.g. in such a way that the higher the payload in the communication channel, or the higher the error rate in the communication channel, the higher the packet offset. The packet offset may be signalled in the bitstream.

In examples, the packet offset between the current packet and the at least one preceding or following packet having the redundant information may be defined by the encoder at least in function of the envisioned application. In examples, the packet offset between the current packet and the at least one preceding or following packet having the redundant information at least in function of an input provided by the end-user.

By virtue of the above, it is now possible to see that redundancy information 1612 or 1612b may be provided to the bitstream 1630 which will help to reconstruct a packet in case that packet is lost from the redundancy information 1612 or 1612b written in a different packet.

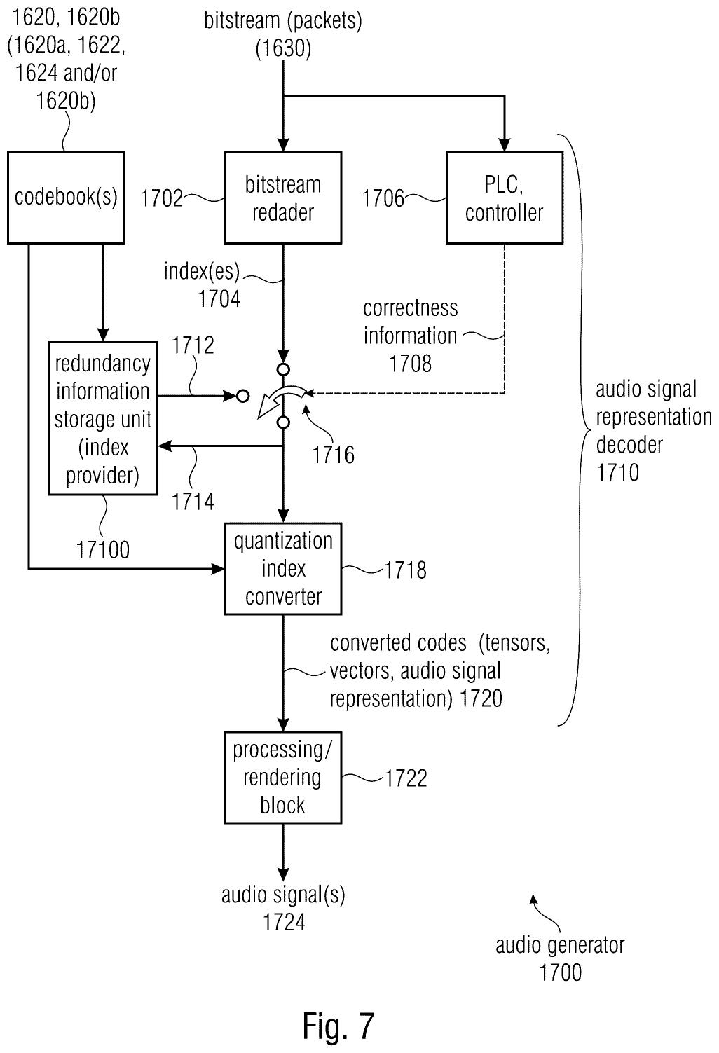

FIG. 7 shows an example of an audio generator 1700. The audio generator 1700 may convert a bitstream 1630 (which in some examples may be the same bitstream of that generated by the encoder 600a or 600b of FIG. 6a or 6b). The audio generator 1700 may generate audio signals 1724 from the bitstream 1630. It is to be noted that the audio signal 1724 that are generally meant at being a trustful representation of the input audio signal 1602 e.g. as provided to the encoders 1600a and 1600b, for example. here a forward error correction (FEC) may be implemented.

It is possible to implement the present examples in an audio signal representation decoder 1710 (which may be or may also not be part of the audio generator 1700). The audio signal representation decoder 1710 may decode an audio representation 1720 which represents the audio signals 1602 (which are to be converted, subsequently, in audio signals 1724). Therefore, it is here explained how the audio signal representation decoder 1710 is constituted according to some examples. The audio signal representation decoder 1710, at first, may decode the audio representation 1720 from the bitstream 1630. The bitstream 1630 is divided in a sequence of packets, e.g. as explained above. The audio signal representation decoder 1710 (or more in particular the audio generator 1700) may comprise a bitstream reader 1702 (e.g. index extractor). The bitstream reader 1702 may sequentially read the sequence of packets (which form the bitstream 1630). The bitstream reader 1702 may extract, from at least one current packet, at least one index 1704 (e.g. a plurality of indexes) of the at least one current packet. From the at least one current packet, redundancy information 1714 giving information on at least one preceding or following packet may be provided to a redundancy information storage unit 17100 (see below). The redundancy information 1714 may be subsequently provided, as redundancy information 1712, for a subsequent packet (in case that packet will be considered as lost), see below. The indexes 1704 extracted by the bitstream reader 1702 may be the indexes 1626 (1623, 1625) or 1623b as inserted in the bitstream 1630 by the encoder 1600a or 1600b, or a representation of them. The redundancy information 1714 may be the redundancy information 1612 and/or 1612b inserted by the redundancy information storage 1610 or 1610b of the encoder 1600a or 1600b, respectively.

The indexes 1704 extracted by the index reader 1702 may then be converted by a quantization index converter 1718.

The audio signal representation decoder 1710 (or in particular the audio generator 1700) may comprise a packet loss controller (PLC) 1706 (which may operate as a FEC controller). The PLC 1706 may check whether the at least one current packet is well received or is to be considered as lost. For example, the PLC may perform a syntactical check on a redundancy code inserted in the bitstream 1630 in association with the current packet (or any other check, e.g. on syntactical redundancy check information). The PLC 1706 may therefore distinguish between the current packet being to be considered correct and the current packet being to be considered as lost. Therefore, the output 1708 of the PLC 1706 may be called correctness information. In case the correctness information 1708 indicates that the current packet is to be considered correct, then the codes (tensors) will be decoded from the indexes of the correct packet. Otherwise, in case the correctness information 1708 indicates that the current packet is to be considered as lost, then the indexes of the current packet of the bitstream are not decode, or at least not used at all. This is represented in FIG. 7 through a switch 1716 which connects the quantization index converter 1718 (which shall output the converted codes of the audio signal representation 1720) either taking the at least one index 1704 of the current packet as lead by the bitstream reader 1702, or from the redundancy information 1712 provided by the redundancy information storage unit (index predictor) 17100. Therefore, when the correctness information 1708 indicates that the current packet is to be considered valid (i.e. correct), then the switch 1716 connects the output of the bitstream reader 1702 to the input of the quantization index converter 1718. When the correctness information 1708 indicates that the current packet is to be considered lost, then the switch 1716 switches to connect the output 1712 of the redundancy information storage unit (index provider) 17100 with the input of the quantization index converter 1718. The output 1712 of the redundancy information storage unit 17100 is redundancy information (e.g. 1612, 1612b) on the current packet, as previously obtained from another packet.

The quantization index converter 1718 may convert the at least one index 1704 (or, alternatively, the redundancy information 1712) into one code or a part of a code 1720. The converted code may be a tensor (such as a vector, but in case it is a vector it shall at least be bi-dimensional). The converter codes 1720 may be, in some examples, meant at being a copy, if possible, of the audio signal representation 1606 in FIGS. 6a and 6b. The audio signal representation 1720 (sequence of codes, such as tensors) may be the output of the audio signal representation decoder 1710. The audio signal representation 1720 may be input into a processing/rendering block 1722 which may generate audio signals 1724.

In case a first packet in the sequence has been considered correct by the PLC 1706, the redundancy information 1714 may comprise one index (e.g., 1626, 1623, 1625, 1623b) of a second, different packet in the bitstream 1630. In case the current packet is considered lost, then the redundancy information 1714 is not provided to the redundancy information storage unit 17100.

We may have the following sequence which is the following:
1. A first packet in the bitstream 1630 is received and, according to the PLC 1706, is considered correct. The correctness information 1708 indicates that the current packet is correct.
2. Then, the switch 1716 connects the output of the bitstream reader 1702 (which is the at least one index 1704, representing the at least one index 1623, 1625, 1626, 1623b of FIGS. 6a, 6b) to the quantization index converter 1718.
3. Moreover, at least one redundancy information 1714 of a second packet of the bitstream 1630 is stored (as 1714) in the redundancy information storage unit 17100 (the redundancy information 1714 may be the redundancy information 1612 or 1612b as provided by the redundancy information storage 1610 or 1610b to the bitstream reader 1628).
4. For a subsequent frame, if the PLC 1706 detects that the format is incorrect, and the packet is to be considered as lost, then the correct information 1708 will indicate that that packet is to be considered lost.
5. Then, the switch 1716 is moved to connect the output 1712 of the redundancy information storage unit (index predictor) 17100 with the input of the quantization index converter 1718. The input 1714 is not provided to the redundancy information storage unit 17100 in this case.

By storing the redundancy information 1714 (e.g., indexes or high-ranking indexes of main portions of tensors of the audio signal representation 1606) it will be possible to reconstruct the audio signal representation 1606, or at least a main portion of it.

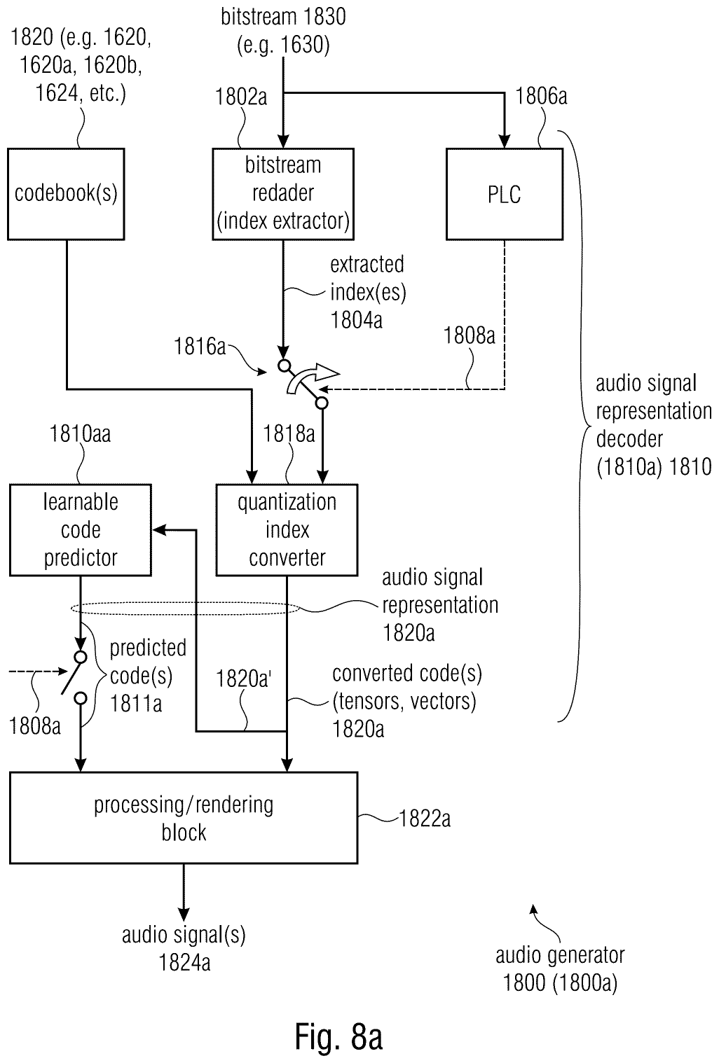

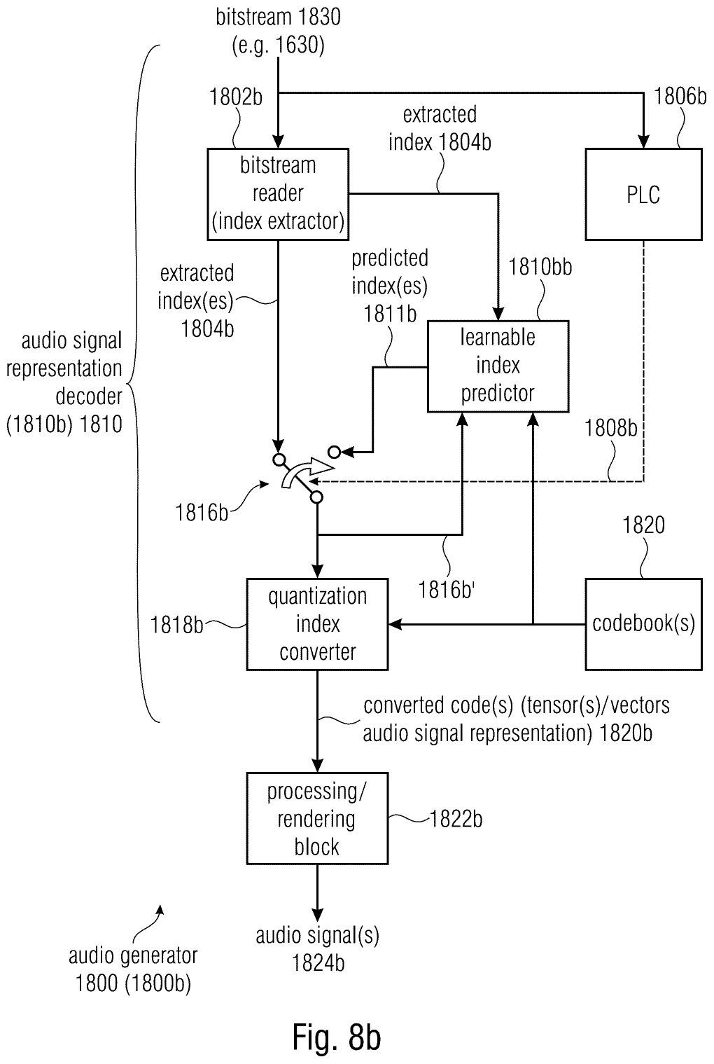

FIG. 7 also shows at least one codebook 1620 which may be a copy of the at least one codebook 1620 or 1620a of any of FIGS. 6a and 6b. The at least one codebook 1620 may also comprise the main codebook 1620a and at least one redundancy codebook 1620b of FIG. 6b. The information obtained from the codebooks may therefore be provided in the same way (Notably, however, the codebooks in the encoders of FIGS. 6a and 6b provide indexes based on codes, while the codebooks of FIGS. 7-8b provide codes based on indexes). Even in this case, it is possible to have at least one high-ranking codebook 1622 and/or at least one low ranking codebook 1624. In general terms, the technique implied for the redundancy information storage unit is the same of that explained for FIGS. 6a and 6b, and is therefore not repeated here. It is to be noted that the codebooks of the audio signal representation decoder 1700 are in general the same as the codebooks of the encoder, so as to permit a correct decoding of the audio signal representation 1720. Since the techniques are the same, the same features are not repeated.

The processing and/or rendering block 1722 may be used, for example, for processing and/or rendering the audio signal 1724 represented by the converted codes 1720.

It is also noted that the redundancy information 1712, used in case a packet is to be considered lost, may be the information obtained from a packet with an offset, with respect to the current packet, defined, for example, by the control 1645′ of FIG. 3b. The offset to be used may be signaled, for example, in the bitstream 1630.

The audio signal representation decoder 1710 may read a signalling indicating a packet offset between the current packet and the at least one preceding or following packet having the redundant information at least in function of the payload of the communication channel, so as to reconstruct the packet to which the redundancy information refers and store the redundancy information associated with the packet to which the redundancy information refers.

In FIG. 7 it is imagined that the redundancy information storage unit 17100 is an index provider which stores indexes. However, it could be possible to have a variant in which the redundancy codes are already obtained by the quantization index converter 1718, and are therefore stored, already converted, in the redundancy information storage unit 17100. In this case, when the redundancy information 1714 is needed (because the current packet is considered as lost), the quantization index converter 1718 may be bypassed, and the redundancy information storage unit 17100 directly provides a portion of the audio signal representation 1720.

FIG. 8a shows an example of an audio generator 1800 which, in this case, is called audio generator 1800a. The audio generator 1800a may comprise an audio signal representation decoder 1810 (in which in this case is referred to as 1810a). The audio signal representation decoder 1810a may be independent of the audio signal generator 1800a. The audio generator 1800a may generate at least one audio signal 1824a from a bitstream 1830. The audio signal representation decoder 1810a, from the bitstream 1830, may generate an audio signal representation 1820a. A processing and/or rendering block 1822a of the audio generator 1800a may be input with the audio signal representation 1820a. Since the audio signal representation decoder 1810a may be independent of the processing and/or rendering block 1822a, the audio signal representation decoder 1800a is now discussed independently of the processing and/or rendering block 1822a.

The bitstream 1830 may be, in some examples, the same bitstream 1630 which is discussed above (e.g., it could be generated by the encoder 1600a and/or by the encoder 1600b and/or remain inputted to the audio signal representation decoder 1710. However, in some examples, the bitstream 1830 may be different from the bitstream 1630: it is not strictly necessary to have the redundancy information 1612 written in the bitstream 1830.

The audio signal representation 1810a may include a bitstream reader (or index extractor) 1802a. This bitstream reader 1802a may be of the same type, in some examples of the bitstream reader 1702 of FIG. 7. However, in this case, no redundancy information is necessarily read (in some cases it is present and in some cases it is not but in some examples it is not necessary to have it). The bitstream reader 1802a may output the extracted indexes 1804a. The audio signal representation decoder 1810a may include a packet loss controller 1806a, which can be of the same type of the PLC 1706. As explained above, the packet loss controller 1806a may operate a check (e.g., based on a cyclic redundancy coding, CRC, or based on analogous techniques) to check whether the format of the received packet in the bitstream 1830 is to be considered correct or is to be considered as lost. The output of the PLC 1806a may therefore be a correctness information 1808a (which can be of the same type of the correctness information 1708 discussed above). The audio signal representation decoder 1810a may include a quantization index converter 1818a. The quantization index converter 1818a may output converted codes 1820a e.g. from the indexes 1804a. The converted codes 1820a may be of the same type of the converted codes 1720 (e.g. they may be tensors, or in some cases in particular vectors, e.g. n×1 vectors with n>1) as discussed above and/or may be, in some examples, a representation of the audio signal representation 1606 of FIGS. 6a and 6b above. The converted codes 1820a may be an output of the audio generator 1800a, at least for those codes converted from indexes extracted from bitstream packets having a correct format (as identified by the PLC 1806a). In case the PLC 1806a has established that a current packet has an incorrect format (and is therefore to be considered as lost), then the PLC 1806a (e.g., through the correctness information 1808a) may cause to skip the conversion of the extracted indices 1804a from the current packet. As can be seen in FIG. 8a, this is represented by a switch 1816a (controlled by the correctness information 1808a) which can selectively prevent the quantization index converter 1818a from receiving the indexes from the bitstream reader 1802a. In case the current packet is considered to be lost, a learnable code predictor 1810aa may be used (FIG. 8a shows the output of the learnable code predictor as being provided based on the correctness information 1808a). The output of the learnable code predictor 1810aa may be predicted codes 1811a. The predicted code(s) 1811a may therefore be provided when the current packet is considered to be lost, instead of the converted codes 1820 to the processing and/or rendering block 1822a, or more in general represents the output, for a particular packet, of the audio signal representation decoder 1810a.

A variant to the audio generator 1800a and of the audio signal representation decoder 1810b is represented in FIG. 8b as audio signal representation 1800b (also collectively called audio generator 1800) and the audio signal representation decoder 1810b (also collectively called 1810). Here, the same elements of FIG. 8a are represented with the same number but with the index “b” instead of “a”. As can be seen, a PLC 1806b (which may therefore be analogous to the PLC 1806a) may output a correctness information 1808b on the format of the current packet of the bitstream 1830. The bitstream reader (index extractor) 1802b may be of the same type of bitstream reader (index extractor) 1802a of FIG. 8a, and may output the extracted indexes 1804b (which may be analogous to the extractor indexes 1804a of FIG. 8). A quantization index converter 1818b may therefore be inputted with the extracted indexes 1804b when the PLC 1806b has established that the current packet is correct, or by predicted indexes 1811b when the PLC 1806b has decided that the current packet is to be considered as lost. This is the main difference between the audio signal representation decoder 1810b and the audio signal representation decoder 1810a: Here, indexes 1816b′ are predicted by a learnable index predictor 1810bb (and a learnable code predictor 1810aa is not present), but what is present is a learnable index predictor 1810bb which may be inputted with the extracted index 1804b and subsequently the extracted indexes may be used for performing predictions (1811b) for subsequent and/or preceding indexes when the packets are considered as lost (e.g., through the correctness information 1808b). This is represented through a switch 1816b which deviates the output 1804b (extracted indexes) from the bitstream reader 1802 towards the quantization index 1818b and the output 1811b of the learnable index predictor 1810bb and the input of the quantization index converter 1818b.

The quantization index converter 1818b may be of the same type of the quantization index converter 1818a of FIG. 18. As can be understood by comparing FIG. 8b with FIG. 8a, the quantization index converter 1818b is inputted which codes 1804b if the packet is valid, and with the predicted indexes 1811b if the packet is considered lost.

Both the examples of FIGS. 8a and 8b may make use of a codebook 1820. The codebook 1820 may be, in some examples, one or a copy of one of the codebooks 1620, 1620b, 1620a, 1622, 1624, and so on. The codebook 1820 may provide codes 1826 (e.g. 1626, 1623, 1625, 1623b) to the learnable code predictor 1810aa, the quantization index converter 1818a or 1818b, and/or the learnable index predictor 1810bb. Any of the examples above may also be used for implementing the codebook 1820 of FIG. 8a or 8b.

For example, there may be a high-ranking codebook and a low-ranking codebook (which is here indicating, for simplicity, as 1622, and 1624, as well). In the example of FIG. 8a, the learnable code predictor 1810aa may, therefore, predict the code 1811a from an index (taken from the codebook 1820). In case there are high-ranking codebooks and low-ranking codebooks, the code book 1820 may, in some examples, only have a high-ranking codebook (e.g. 1622), thereby providing only a high-ranking index 1623 to the learnable code predictor 1810. The prediction at the learnable code predictor 1810aa, therefore, may be restricted to only a high-ranking codebook (e.g. only the highest-ranking codebook). In some examples, the learnable code predictor 1810aa may learn the prediction from the currently converted codes 1820a, so as to perform predictions based on the previous conversions of the correct packets. This is the sense of the arrow 1820a′ from the converter codes 1820a outputted by the quantization in the quantization index converter 1818a towards the learnable code predictor 1810aa.

Analogous strategies may be performed in the audio signal representation decoder 1810b, where the learnable index predictor 1810bb may be inputted with at least one code 1820 (which may be the same of FIG. 8a, and which may be any of 1620, 1620a, 1620b and 1624, etc.). Here, the codebook 1820 may provide an index to the quantization index converter 1818b (for correcting the indexes 1804b extracted from correct packets) and/or to the learnable index predictor 1810bb (e.g. for predicting indexes 1811b when the packets are held incorrect). As shown in FIG. 8b, the arrow 1816b′ connects the extracted indexes 1816b (when correct) with the input of the learnable index predictor 1810bb, so that the learnable index predictor 1810bb can learn the correct indexes. Of course, when the indexes are predicted by the learnable index predictor 1810bb, there is no necessity of providing the input 1816b′ to the learnable index predictor 1810.

As explain above and below, high-ranking vs low-ranking codebooks may be used in case of split quantization or residual quantization. For example, a base codebook (high-ranking) may be used for decoding a main portion of a main portion code (or a main subcode), and a low-ranking codebook may be used for decoding a residual portion of a code (or a low-ranking subcode). Then, it is possible to add the main portion of the code with the residual portions of the code (e.g. by addition) and to put together the different subcodes with each other, so as to obtain the converted code.

In some cases, there are not different ranking for different subcodes, but still different codebooks.

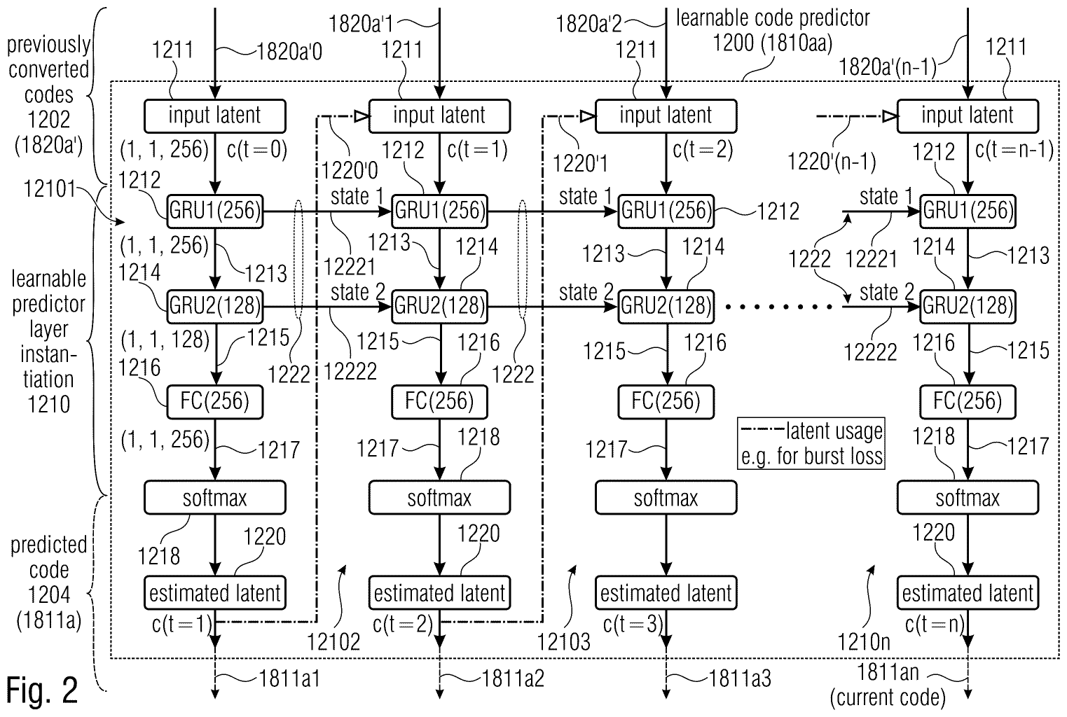

FIG. 2 shows an example of learnable code predictor 1200 which may be, for example, the learnable code predictor 1810aa of the audio signal representation decoder 1810a of FIG. 8a. FIG. 2 shows a sequence of previously converted codes 1202, which may be the previously converted codes 1820a′ part of the audio signal representation 1820a converted by the quantization index converter 1818a. The previously converted codes 1202 (which may be the codes 1820a′ shown in FIG. 8a) are here shown in a sequence. If the current code is the n^{th} of the sequence (and is therefore considered to be at time t=n), the previously predicted codes may be:
a 0^{th} previously converted code 1820a′0 (for a packet at time instant t=0),
a 1^{st} previously converted code 1820a′1 (converted from the packet at the time t=1),
a 2^{nd} converted code 1828′2 (converted from the packet at the time t=2),
. . .
a current (last) converted code 1820a′n (converted from the packet at the t=n−1).

To predict the current n^{th} code, the prediction is obtained as estimated code 1811an for the current code (t=n). For the preceding predicted codes (1811a3, 1881a2, and 1811a1) are also obtained for previous time instances (t=3, t=2, t=1). It is to be noted that, in some examples, the sequence may be restricted to a predetermined number of preceding time instants (e.g. the last 5, or 10, or 20 packets, for example).

The output of the learnable code predictor 1200 (1810aa) may be the sequence 1204 of predicted codes (which may be, for example, the predicted codes 1811a predicted by the learnable code predictor 1810aa of FIG. 8a). As can be seen, the learnable code predictor 1200 (1810aa) may comprise at least one learnable predictor layer. The at least one learnable predictor layer may include at least one recurrent learnable layer (e.g. recurrent neural network). The at least one learnable predictor layer may include at least one gated recurrent unit. More in general, the audio signal representation decoder 1800 may be autoregressive.

The at least one learnable predictor layer may be iteratively instantiated, along a sequential plurality of predictor layer instantiations, along the sequence of packets for which the codes are sequentially predicted. An example of learnable predictor layer instantiations (which are collectively referred to with 1210) includes:
a learnable predictor layer instantiation 12101 for predicting the 1^{st} code 1811a1 (t=1
a learnable predictor layer instantiation 12102 for predicting the 2^{nd} code 1811a2 (t=2),
a learnable predictor layer instantiation 12103 for predicting the 3^{rd} code 1811a3 (t=3)
. . .
A current (last) learnable predictor layer instantiation 1210n, predicting the current n^{th} code 1811an (t=n).

In examples, the learnable predictor layer instantiations (12101, 12102, 12103, . . . , 1210n) are meant at being sequentially and/or iteratively performed for the sequence of codes 1811a1, 1811a2, 1811a3, . . . , 1811an that have to be predicted. For this reason, after the current instantiation 1210n for predicting the code 1811an, there will be new instantiation 1210(n+1) for predicting the subsequent code 1811a(n+1).

As shown in FIG. 8a, each instantiation 1210 may have an input 1211 which is selectably either:
the at least one (e.g. immediately) preceding predicted code (e.g., 1811a1, provided as input 1220′0 from the first instantiation 12101 to the second instantiation 12102; 1811a2, provided as input 1220′1 from the 2^{nd} instantiation 12102 to the 3^{rd} instantiation 12103; . . . 1811a(n−1), provided as input 1220′(n−1) from the (n−1)^{th} instantiation, not shown, to the current n^{th} instantiation 1210n)
the at least one (e.g. immediately) preceding converted code (e.g., 1820a′0 for the first instantiation 12101; 1820a′1, provided to the 2^{nd} instantiation 12102; . . . 1820a′(n−1), provided to the current n^{th} instantiation 1210n).

As it can be seen from FIG. 2, each learnable predictor layer instantiation 1210 may comprise at least one (e.g. two) learnable layers (e.g. 1212, 1214) having a state. The state is collectively referred to with 1222, and here includes a state 1 of a first layer 1212 being refer to with 12221, and a state 2 of a second layer 1214 being referred to with 12222.

The state may be provided from a preceding instantiation (e.g. the immediately subsequent instantiation) to a subsequent instantiation (e.g. up to the current instantiation 1210n). For example, the state 1222 of the instantiation 12101 is provided to the instantiation 12102 (in this case, the state 12221 of the first layer 1212 of the instantiation 12101 is provided to the first layer 1212 of the immediately subsequent instantiation 12102, and the state 12222 of the second layer 1214 of the instantiation 12101 is provided to the second layer 1214 of the immediately subsequent instantiation 12102). Analogously, the state of the predictor 1222 of the instantiation 12102 (and in particular of layers 1212 and 1214) is provided to the instantiation 12103 (in particular to layers 1212 and 1214). Analogously, the current instantiation 1210n receives the state 1222 from the preceding instantiation (which is not shown in FIG. 2). Therefore, when a code is predicted, it is predicted through a learnable predictor layer instantiation which has a state which takes into account the state of a preceding instantiation (e.g. the immediately preceding instantiation). For example, the current n^{th} predicted code 1811an is obtained through layers 1212 and 1214 of the current n^{th} instantiation 1210n, taking into account the state 1222 of the immediately preceding iteration 1210(n−1) (and in particular of the layers 1212 and 1214 of the immediately preceding iteration 1210(n−1)).

To predict the current code (e.g. 1811an), the current learnable predictable layer instantiation 1210n receives in input 1211 which is selected between:
the at least one preceding converted code 1820′a (n−1) in case the at least one preceding packet is considered well received (thereby actuating the connection 1820a′ in FIG. 8a); or
the at least one preceding predicted code 1220′(n−1) in case the at least one preceding packet is considered as lost.

However, to predict the current code 1811an, the last learnable predictor layer instantiation 1210n receives the state 1222 (12221, 12222) from the at least one preceding (e.g. immediately preceding) iteration both in case the at least one preceding packet is considered well received and in case in case the at least one preceding packet is considered as lost.

As can be understood, therefore, each instantiation 1210 has, at its input 1211, either a previously converted code 1202 (1820a′ such as 1820a′0, 1820a′1, 1820a′2, 1820a′(n−1)) or the previously predicted code (e.g. 1811a1 provided as 1220′0 to the input 1211 of the instantiation 12102, 1811a2 provided as 1220′ to the input 1211 of the instantiation 12103, and 1220′(n−1) provided as input 1211 of the current instantiation 1210n). Therefore, for each input 1211 of each instantiation 1210, either the previously corrected code 1820a′ or the previously predicted code 1204 (1811a) is provided as input to each iteration. In the present examples, it is here mostly imagined that each duration receives the codes and states from the immediately preceding iterations, even though some generalizations are possible to preceding iterations which are not the immediately preceding instantiations (iterations). Therefore, when the current code (e.g. 1811an) is predicted, the immediately previously converted codes (obtained from correct packets are taken into consideration and, in case some previously received packets are not held correct, then the previously predicted codes are taken into consideration. In any case the state 1222 may be provided from each instantiation to the following instantiation (e.g. the immediately following instantiation), so that both in case the previous packet is corrected or not, something is inherited independently from the other previous packets.

Let us consider the situation that, in order to predict the current n^{th} code 1811an, the immediately preceding code n−1 is previously converted by the quantization index converter 1818a (because the immediately preceding packet has been received correctly). In this case, in order to predict the current n^{th} code, the learnable predictor layer instantiation 1210n is not inputted (at latent 1211) with the immediately previous predicted code 1120′(n−1) as outputted by the preceding iteration, but with the immediately previous converted code 1820a′(n−1) (as outputted by the converter 1818a). However, the instantiation 1210(n−1) for predicting the (n−1)^{th} code is performed notwithstanding. One could imagine that, since the (n−1)^{th} code is taken from a correct packet, there would be no necessity of providing the state 1222 from the (n−1)^{th} instantiation 1210(n−1) to the current n^{th} instantiation 1210n: this is because one could imagine that, by virtue of the immediately preceding (n−1)^{th} code 1820a′(n−1) being converted from a correct packet, there would be no necessity of inheriting also the state(s) 1222 from the previous iterations (e.g. 1210(n−1)). However, it has been understood that, by passing the state 1222 to the current iteration 1210n from the preceding iteration 1210(n−1) (even when the preceding code was taken from a correct packet), something from the more preceding iterations (e.g. 1210(n−2), 1210(n−3), etc.) can be handed down to the current iteration 1210n (and, more importantly, something from the preceding (n−2)^{th}, (n−3)^{th}, etc. codes will be inherited by the n^{th} code). It has been understood that, in order to generate at least a portion of the audio signal representation 1820a, the prediction may advantageously also take into consideration not only the immediately preceding code (either converted or predicted), but also some more preceding codes which are before the immediately preceding code. In this way, the state is obtained also from the preceding codes which are not the immediately preceding code and, accordingly, an increased reliability is achieved.

Let us assume, for example, that:
the 0^{th} and 1^{th} previously converted codes (1820a′0 and 1820a′1) are taken from correctly-received packets, and therefore the instantiations 12101 and 12102 provide correct states 1222 to the immediately subsequent instantiations 12102 and 12103, respectively
the 2^{nd}, 3^{rd}, . . . (n−1)^{th} codes are taken from corrupted packets, and therefore the 2^{nd}, 3^{rd}, . . . (n−1)^{th} instantiations 12103, 12104 . . . 1210(n−1) (which cannot be inputted with the converted codes 1810′2, 1820′3, 1820′(n−2), since they would be taken from incorrect packets, but shall be inputted with previously predicted codes 1220′1, 1220′1, 1220′(n−2), respectively) provide states 1222 to the immediately subsequent instantiations 12103, 1204, . . . 1210n, respectively.

At a first sight, one could imagine these states provided to the instantiations 12103, 1204, . . . 1210n to be invalid, by virtue of being based on predictions, and not on corrected data. However, it has been understood that, in this way, the instantiations 12103, 12104 . . . 1210(n−1), despite being associated with corrupted packets, may notwithstanding provide (to the subsequent instantiation) a state which has a good amount of correctness, since this state is, notwithstanding, inherited, for some amount, to previously correct states.

Each learnable predictor layer instantiation 1210n may include at least learnable convolution unit 1216. That may be, as obtainable, at the at least one recurrent unit 1212, 1214 of the current learnable layer 1210n is inputted with a state from a correspondent at least one recurrent unit 1212, 1214 from the at least one preceding learnable predictor layer instantiation, and outputs a state to a corresponding at least one recurrent unit 1212, 1214 of at least one subsequent learnable predictor layer instantiation.

In some example, each current learnable predictor layer instantiation has a series of learnable layers [e.g. each learnable layer of the series, apart from the last one, outputs a processed code to the immediately subsequent layer of the series, and the last learnable layer of the series output a code to the immediately subsequent learnable predictor layer instantiation][e.g. for each learnable predictor layer instantiation, apart from the last learnable predictor layer instantiation, each learnable layer of the series outputs its state to the corresponding learnable layer of the immediately learnable predictor layer instantiation].

In some example, each learnable predictor layer instantiation, the series of learnable layers includes at least one dimension-reducing learnable layer (1214) [e.g. GRU2] and at least one dimension-increasing learnable layer 1216 [e.g. FC] subsequent to the at least one dimension-reducing learnable layer [e.g. so that the output of the learnable predictor layer instantiation has the same dimension of the input of the learnable predictor layer instantiation].

In some examples (e.g. FIG. 2), the at least one dimension-reducing learnable layer 1214 [e.g. GRU2] includes at least one learnable layer with a state, [e.g. in such a way that each learnable predictor layer instantiation, apart from the last learnable predictor layer instantiation, provides the state of the at least one dimension-reducing learnable layer to the at least one dimension-reducing learnable layer of the immediately subsequent learnable predictor layer instantiation].

In some example (e.g. FIG. 2), the at least one dimension-increasing learnable layer (1216) [e.g. FC] includes at least one learnable layer without a state, [e.g. in such a way that no predictor layer instantiation provides the state of the at least one dimension-increasing learnable layer to the at least one dimension-increasg learnable layer of the immediately subsequent learnable predictor layer instantiation].

In some examples (e.g. FIG. 2) the series of learnable layers is gated.

In some examples (e.g. FIG. 2) the wherein the series of learnable layers is gated through a softmax activation function.

Here below, there is illustrated a possible sequence of a series of a learnable predictor layer instantiation (e.g. 1210n):
At the input (input latent) 1211, there may be either a previously converted code 1202, 1820a′ (e.g. 1820a′(n−1)), or a previously predicted code 1204, 1811a, (e.g. 1220′(n−1)).
A first recurrent unit (e.g. an iterated recurrent unit 1212) which may convert the input latent 1211 from a first invention (e.g. 1, 1, 256) to a second dimension (to the same dimension), obtaining an output 1215. The output 1215 being reduced from the dimension 1, 1, 256 to a second dimension 1, 1, 128.

In some examples, there is defined a gated unit (e.g. inputted with the state 1, 12222, from the immediately preceding iteration) having
Convolutional layer 1216 (e.g. a layer with state) which can have an input value 1215 and output value 1217 with an increased dimension (1, 1, 256)
An Activation function 1218 (e.g. softmax), so as to arrive at an estimated latent 1220 to be used as a predicted code for the current packet (e.g. 1811an) and to be provided to the immediately subsequent learnable predictor layer instantiation for the immediately subsequent code to be predicted.

Of course, also the states may be provided from the recurrent layers 1212 and 1214 to the correspondent reoccurring layers of the immediately subsequent learnable predictable layer instantiation.

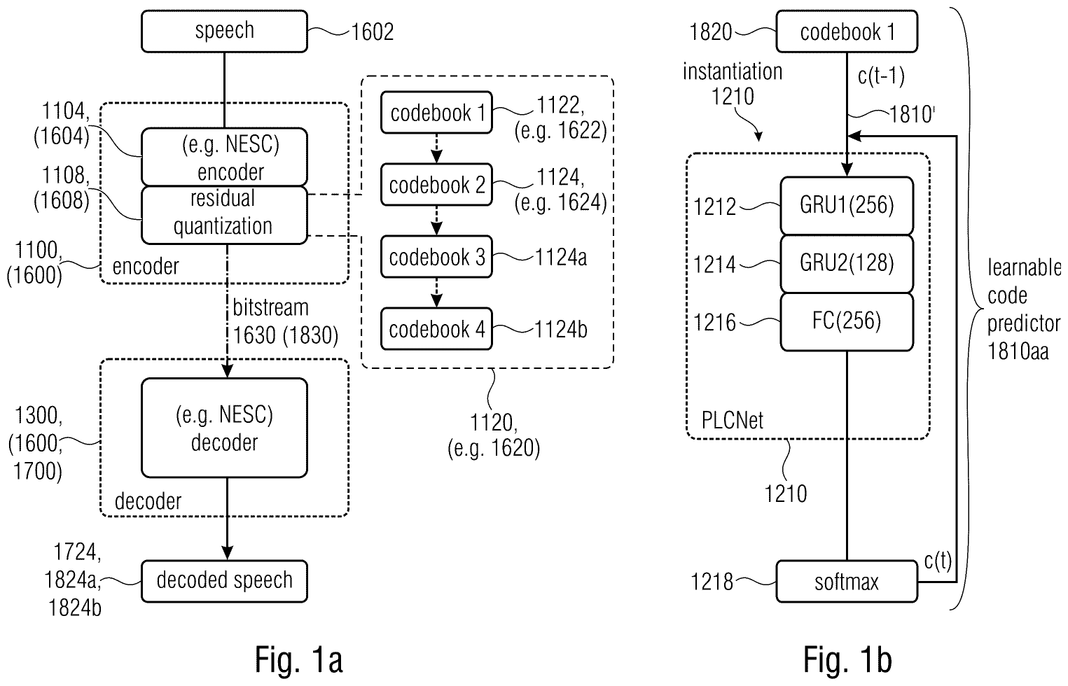

FIG. 1a shows an example of a decoder 1100, which may be one of the encoders 1600, (such as 1600a and 1600b as discussed above) which may include, for example, a learnable audio signal representation generator (here indicated as “NESC encoder”) 1104 (which may be instantiated, for example, by the learnable audio signal representation generator 1604). A residual quantization step (an example of which, can be, for example, the quantizer 1608 discussed above or for FIGS. 6a and 6b) which may make use of a at least one codebook (e.g. a base codebook 1122, which may be the base codebook 1622 as above, a first ranking codebook 1124, which may be the low-ranking codebook 1624 of above, an even lower codebook 1224a and a lowest codebook 1124b). The bitstream is indicated as bitstream 1630 but could also be 1830 in some examples.

The decoder is indicated with 1300 and could be one of the decoders 1600 and 1700 discussed above. The result may be an audio signal rendered 1724.

FIG. 1b shows a more conceptual example of FIG. 2. Here, it can be seen the codebook 1820, the converted codes 1810′ (which may be provided, through 1820a′, to the learnable code predictor 1820aa), the learnable layers 1212, 1214, which are gated recurrent units, the convolutional layer 1216.

The examples of the audio signal representation decoders 1710, 1810a, 1810b of FIGS. 7-8b are not necessarily disjointed with each other. For example, an audio signal representation decoder may embody, at the same time, both the audio signal representation decoders 1710 and 1810a. This because the audio signal representation decoder may include both a redundancy storage unit 17100 (e.g., for storing redundant information 1714 from the bitstream 1630) and a learnable code predictor 1818aa like in FIG. 8a (e.g., for predicting codes 1811a like in FIGS. 8a and 2 from the bitstream 1630 when no redundancy information has been stored yet).

It is noted that the examples of FIGS. 7-8b may be mixed together. For example, an audio representation decoder may have both the learnable code predictor 1810aa of FIG. 8a and the redundancy information storage unit 17100 of FIG. 7. In this case, the learnable code predictor 1810aa may be activated only in case no redundancy information is retrieved at the redundancy information storage unit 17100.

For example, in case the at least one current packet is to be considered as lost, it is possible to search the redundancy information storage unit 17100, and, in case the redundancy information referring to the at least one current packet is retrieved, the at least one index is retrieved from the redundancy information referring to the current packet and the quantization index converter converts the at least one retrieved index from the at least one codebook onto a substitutive code. The processing block may therefore generate the at least one portion of the audio signal by converting the at least one substitutive code onto the at least portion of the audio signal. Otherwise, in case the redundancy information is not retrieved, then the prediction is actuated by the learnable code predictor 1810aa, and the predicted code is used to as code of the audio signal representation 1820a.

The same may be provided, for example, by implementing an audio representation decoder having both the learnable index predictor 1810bb of FIG. 8b and the redundancy information storage unit 17100 of FIG. 7. In this case, the index prediction will only be performed in case no redundancy information is retrieved in the redundancy information storage unit 17100. In examples above, it is often referred to the fact that redundancy information is written in the bitstream. In some examples (e.g. sin some examples implementing split quantization or residual quantization), the encoder 1600a or 1600b may write in the bitstream, as redundancy information, only the highest ranking index, while the lower ranking index(es) may be skipped. In this way, the audio signal representation decoder (e.g., 1710, 1810a, 1810b) may store the redundancy information and use it. The payload will be reduced, and an acceptable degree of reliability will notwithstanding be achieved.

In addition or alternative, the higher ranking indexes may be used, for example, in the example of FIG. 2 (e.g. as previously converted coders 1202, such as 1820a′0 . . . 1820a′n), therefore reducing the computational effort for the learnable predictor 1200 (1810a), because the lower ranking indexes are not predicted.

It is noted that the learnable predictor (1200, 1810a, 1810b) may be trained by sequentially predicting predicted current codes, or respectively current indexes, from preceding and/or following packets, and by comparing the predicted current codes, or the current codes obtained from predicted indexes, with converted codes converted from packets having been well received, so as to learn learnable parameters of the at least one learnable predictor layer which minimize errors of the predicted current codes with respect the converted codes converted from the packets having correct format.

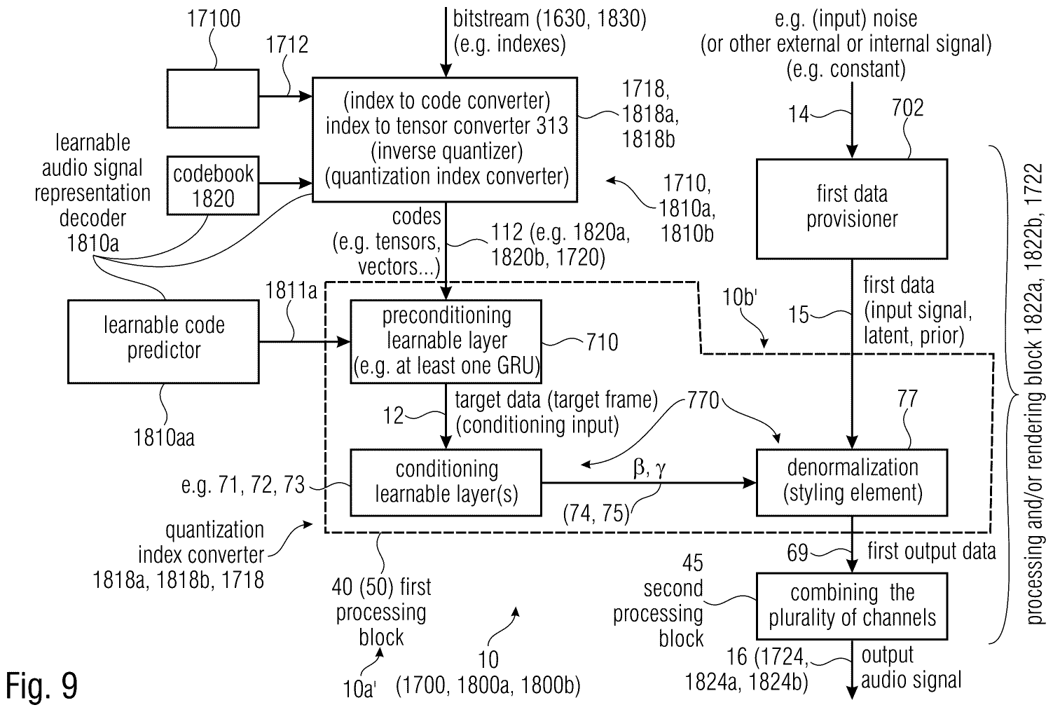

FIG. 9 shows an example of audio generator 10 (which may be one of 1700, 1800a, 1800b). Here, we may recognize:
The audio generator 10, which may be an example of the audio generator 1700 and/or 1800a
The audio signal representation decoder 1710 or 1810a.
The codebook 1820 (which may be one of the codebooks 1620, 1622, 1624, 1620b, 1620a, 1122, 1124, 1124a, 1124b, etc.)
The learnable code predictor 1810aa of FIG. 8a (which may, however, also be implemented in an example of FIG. 8b or 7).
The redundancy information storage unit 17100 of FIG. 7 (which may, however, also be implemented in an example of FIG. 8a or 8b)
The bitstream 1630, 1830 (for all the examples, also indicated with 3)
The quantization index converter 1718, 1818a, 1818b (for all the examples, also referred to as 313)
The decoded audio signal representation (codes, tensors, vectors) 1820a, 1820b, 1720 (for all the examples, also referred to with 112)
The processing and/or rendering block 1722, 1822a, 1822b
The output audio signal 1724, 1824a, 1824b (for all the examples, also referred to with 16).

It is important to note that the examples of FIGS. 9-13 are not necessarily be implemented, and there are other techniques which may be implemented.

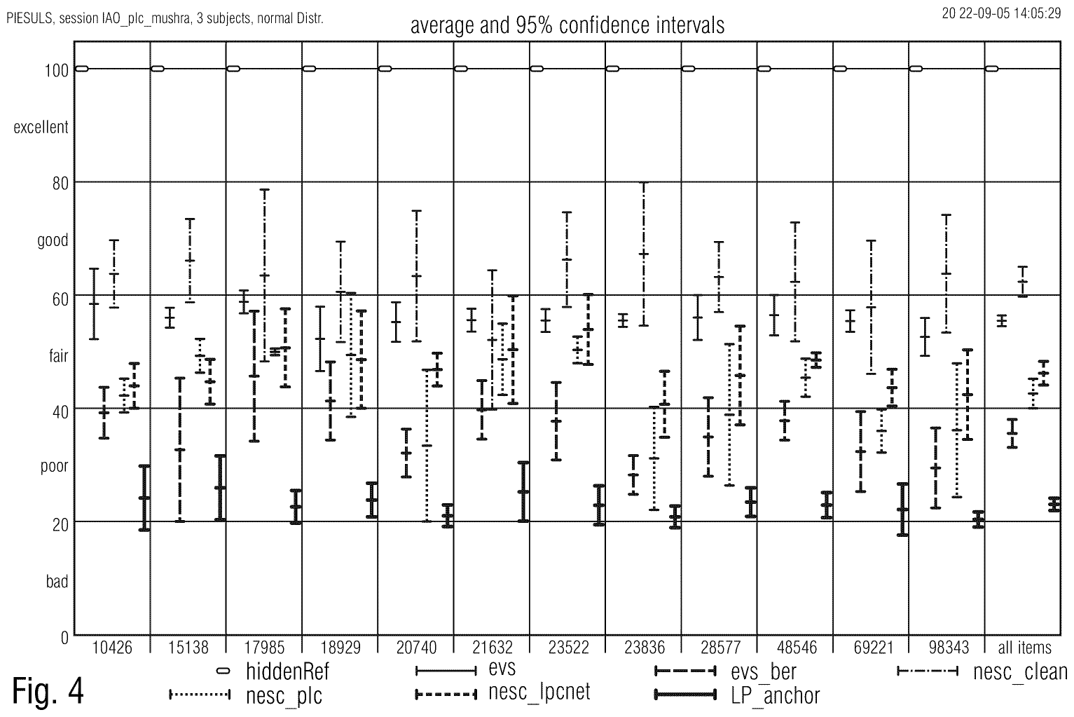

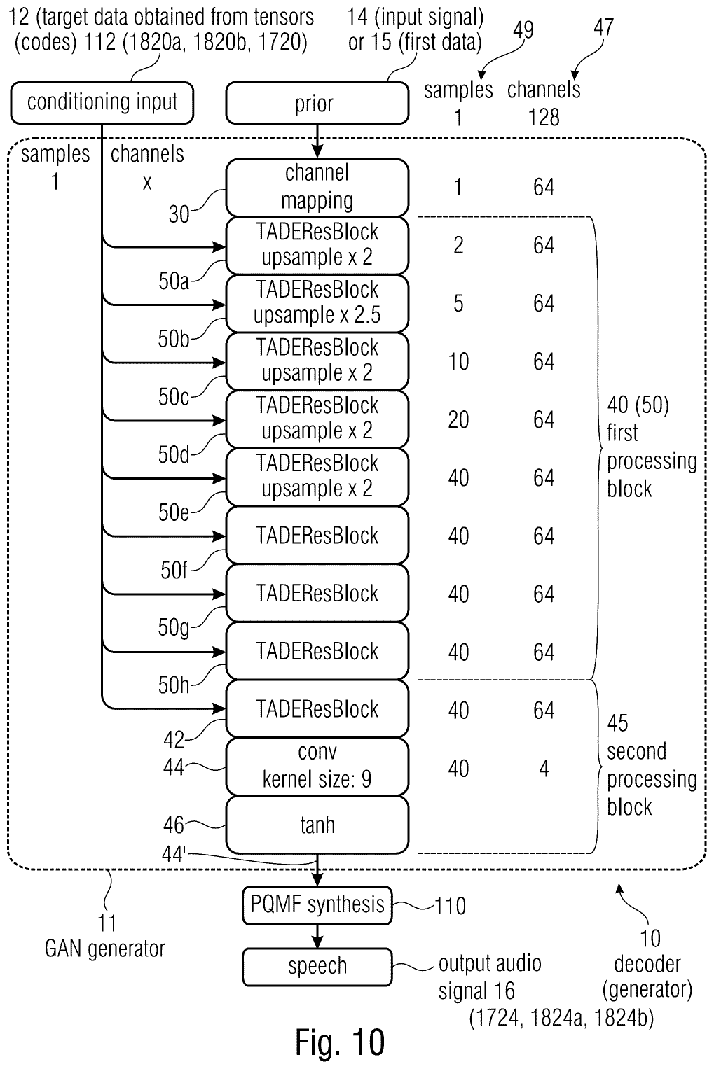

The bitstream 3 (e.g. 1630 or 1830) (obtained in input) may comprise frames (e.g. encoded as indexes, e.g. encoded by the encoder 1600a or 1600b). An output audio signal 16 (e.g. one of 1724, 1824a, 1824b) may be obtained. The audio generator 10 (1700, 1800a, 1800b) may include a first data provisioner 702. The first data provisioner 702 may be inputted with an input signal (input data) 14 (e.g. from an internal source, e.g. a noise generator or a storage unit, or from an external source e.g. an external noise generator or an external storage unit or even data obtained from the bitstream 3). The input signal 14 may be noise, e.g. white noise, or a deterministic value (e.g. a constant). The input signal 14 may have a plurality of channels (e.g. 128 channels, but other numbers of channels are possible, e.g. a number larger than 64). The first data provisioner 702 may output first data 15. The first data 15 may be noise, or taken from noise. The first data 15 may be inputted in at least one first processing block 50 (40). The first data 15 may be (e.g., when taken from noise, which therefore corresponds to the input signal 14) unrelated to the output audio signal 16 (e.g. 1724, 1824a, 1824b). The at least one first processing block 50 (40) may condition the first data 15 to obtain first output data 69, e.g. using a conditioning obtained by processing the bitstream 3 (e.g. 1630 or 1830). The first output data 69 may be provided to a second processing block 45. From the second processing block 45, an audio signal 16 (e.g. 1724, 1824a, 1824b) may be obtained (e.g. through PQMF synthesis). The first output data 69 may be in a plurality of channels. The first output data 69 may be provided to the second processing block 45 which may combine the plurality of channels of the first output data 69 providing an output audio signal 16 (e.g. 1724, 1824a, 1824b) in one signal channel (e.g. after the PQMF synthesis, e.g. indicated with 110 in FIGS. 4 and 10, but not shown in FIG. 9).

As shown by FIG. 9, in a frame-by-frame branch 10a′, indexes may be provided to the quantization index converter 313 (which may be one of 1718, 1818a, 1818b) to obtain codes (e.g. vectors or more in general tensors) 112 (e.g. any of 1704, 1804a, 1804b). The codes 112 (1704, 1804a, 1804b) may be multi-dimensional (e.g. bidimensional, tridimensional, etc.) and may be here understood as being in the same format (or in a format which is analogous or similar to) the format of the audio signal representation outputted by the audio signal representation generator 1604 in FIG. 6a or 6b. The quantization index converter 313 (1718, 1818a, 1818b) may therefore be understood as performing the reverse operation of the quantizer 1608 of FIGS. 6a and 6b. As explained above, the quantization index converter 313 (1718, 1818a, 1818b) may be connected to learnable codebooks (e.g. 1820, 1620, 1620a, 1620b, 1624, etc.), as discussed for example, for FIGS. 7-8b. The quantization index converter 313 (1718, 1818a, 1818b) may be trained together with the quantizer and, more in general, together with the other elements of the encoder 1600a, 1600b, and/or the audio generator 10 (1700, 1800a, 1800b). The quantization index converter 313 (1718, 1818a, 1818b) may operate in a frame-by-frame fashion, e.g. by considering a new index for each new frame to generate. Hence each code (e.g. vector or more in general tensor . . . ) 112 (1704, 1804a, 1804b) has the same structure of each of latent representation which was quantized, without necessary sharing the exact same value but rather an approximation of them.

A sample-by-sample branch 10b′ may be updated for each sample e.g. at the output sampling rate and/or for each sample at a lower sampling-rate than the final output sampling-rate, e.g. using noise 14 or another input taken from an external or internal source.

It is also to be noted that the bitstream 3 (e.g. 1630 or 1830) is here considered to encode mono signals and also the output audio signal 16 (e.g. 1724, 1824a, 1824b) and the original audio signal 1602 are considered to be mono signals. In the case of stereo signals or multi-channel signals like loudspeaker signal or Ambisonics signal for example, then all the techniques here are repeated for each audio channel (in stereo case, there are two input audio channels 1, two output audio channels 16, etc.).

“channels” is here understood in the context of convolutional neural networks, according to which a signal is seen as an activation map which has at least two dimensions: a plurality of samples (e.g., in an abscissa dimension, or e.g. time axis); and a plurality of channels (e.g., in the ordinate direction, or e.g. frequency axis).

The first processing block 40 may operate like a conditional network (e.g. conditional neutral network), for which data from the bitstream 3 (e.g. 1630 or 1830) (e.g. codes vectors or more in general tensors 112) are provided for generating conditions which modify the input data 14 (input signal). The input data (input signal) 14 (in any of its evolutions) will be subjected to several processings, to arrive at the output audio signal 16 (e.g. 1724, 1824a, 1824b), which is intended to be a version of the original input audio signal 1. Both the conditions, the input data (input signal) 14 and their subsequent processed versions may be represented as activation maps which are subjected to learnable layers, e.g. by convolutions. Notably, during its evolutions towards the speech (e.g. 1724, 1824a, 1824b), or more in general the generated audio signal 16, the signal may be subjected to an upsampling (e.g. from one sample 49 to multiple samples, e.g. thousands of samples, in FIG. 10), but its number of channels 47 may be reduced (e.g. from 64 or 128 channels to single channel).

First data 15 may be obtained (e.g. the sample-by-sample branch 10b′), for example, from an input (such as noise or a signal from an external signal), or from other internal or external source(s). The first data 15 may be considered the input of the first processing block 40 and may be an evolution of the input signal 14 (or may be the input signal 14). The first data 15 may be considered, in the context of conditional neural networks (or more in general conditional learnable blocks or layers), as a latent signal or a prior signal. Basically, the first data 15 is modified according to the conditions set by the first processing block 40 to obtain the first output data 69. The first data 15 may be in multiple channels, e.g. in one single sample. Also, the first data 15 as provided to the first processing block 40 may have the one sample resolution, but in multiple channels. The multiple channels may form a set of parameters, which may be associated to the coded parameters encoded in the bitstream 3 (e.g. 1630 or 1830). In general terms, however, during the processing in the first processing block 40 the number of samples per frame increases from a first number to a second, higher number (i.e. the bitrate increases from a first bitrate to a second, higher bitrate). On the other side, the number of channels may be reduced from a first number of channels to a second, lower number of channels. The conditions used in the first processing block (which are discussed in great detail below) can be indicated with 74 and 75 and are generated by target data 12, which in turn are generated from target data 12 obtained from the bitstream 3 (e.g. 1630 or 1830). It will be shown that also the conditions (conditioning feature parameters) 74 and 75, and/or the target data 12 may be subjected to upsampling, to conform (e.g. adapt) to the dimensions of the versions of the target data 12. The unit that provides the first data 15 (either from an internal source, an external source, the bitstream 3 (e.g. 1630 or 1830), etc.) is here called first data provisioner 702.

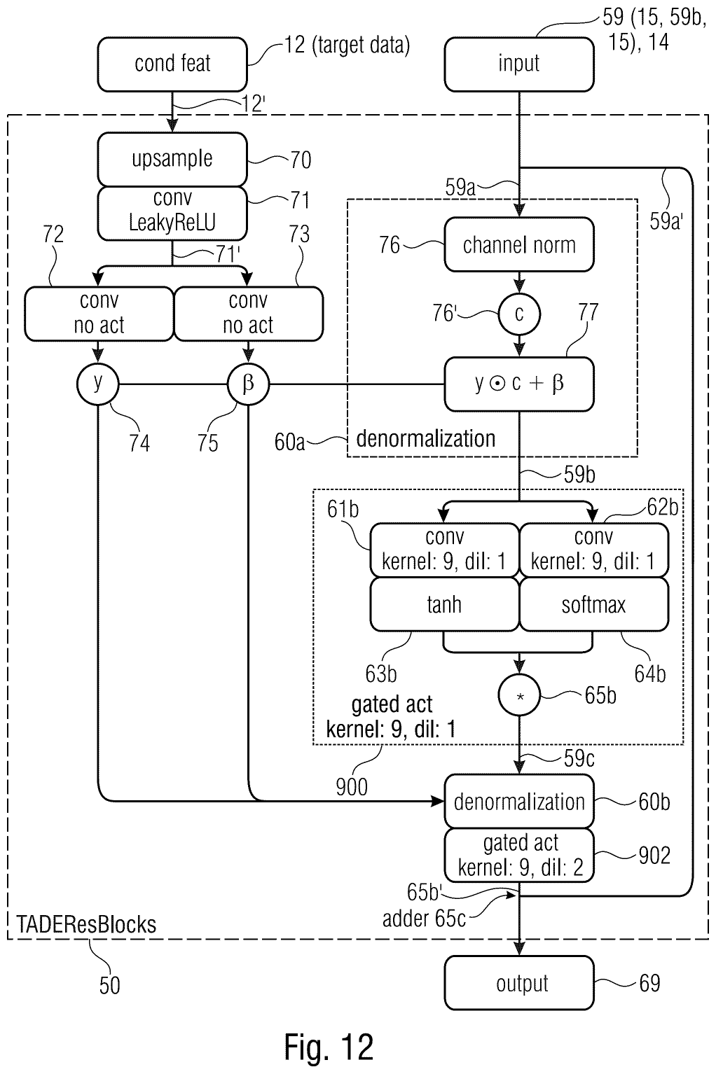

As can be seen from FIG. 9, the first processing block 40 may include a preconditioning learnable layer 710, which may be or comprise a recurrent learnable layer, e.g. a recurrent learnable neural network, e.g. a GRU. The preconditioning learnable layer 710 may generate target data 12 for each frame. The target data 12 may be at least 2-dimensional (e.g. multi-dimensional): there may be multiple samples for each frame in the second dimension and multiple channels for each frame in the first dimension. The target data 12 may be, in some examples, in the form of a spectrogram, which may be a mel-spectrogram, e.g. in case the frequency scale is non-uniform and/or is motivated by perceptual principles. In case the sampling rate corresponding to conditioning learnable layer to be fed is different from the frame rate, the target data 12 may be the same for all the samples of the same frame e.g. at a layer sampling rate. Another upsampling strategy can also be applied. The target data 12 may be provided to at least one conditioning learnable layer, which is here indicated as having the layer 71, 72, 73 (also see FIG. 12 and also below). The conditioning learnable layer(s) 71, 72, 73 may generate conditions (some of which may be indicated as β, beta, and γ, gamma, or the numbers 74 and 75), which are also called conditioning feature parameters to be applied to the first data 12, and any upsampled data derived from the first data. The conditioning learnable layer(s) 71, 72, 73 may be in the form of matrixes with multiple channels and multiple samples for each frame. The first processing block 40 may include a denormalization (or styling element) block 77. For example, the styling element 77 may apply the conditioning feature parameters 74 and 75 to the first data 15. An example may be element wise multiplication of the values of the first data by the condition β (which may operate as bias) and an addition with the condition γ (which may operate as multiplier). The styling element 77 may produce a first output data 69 sample by sample.

The decoder (audio generator) 10 (1700, 1800a, 1800b) may include a second processing block 45. The second processing block 45 may combine the plurality of channels of the first output data 69, to obtain the output audio signal 16 (e.g. 1724, 1824a, 1824b) (or its precursor the audio signal 44′).

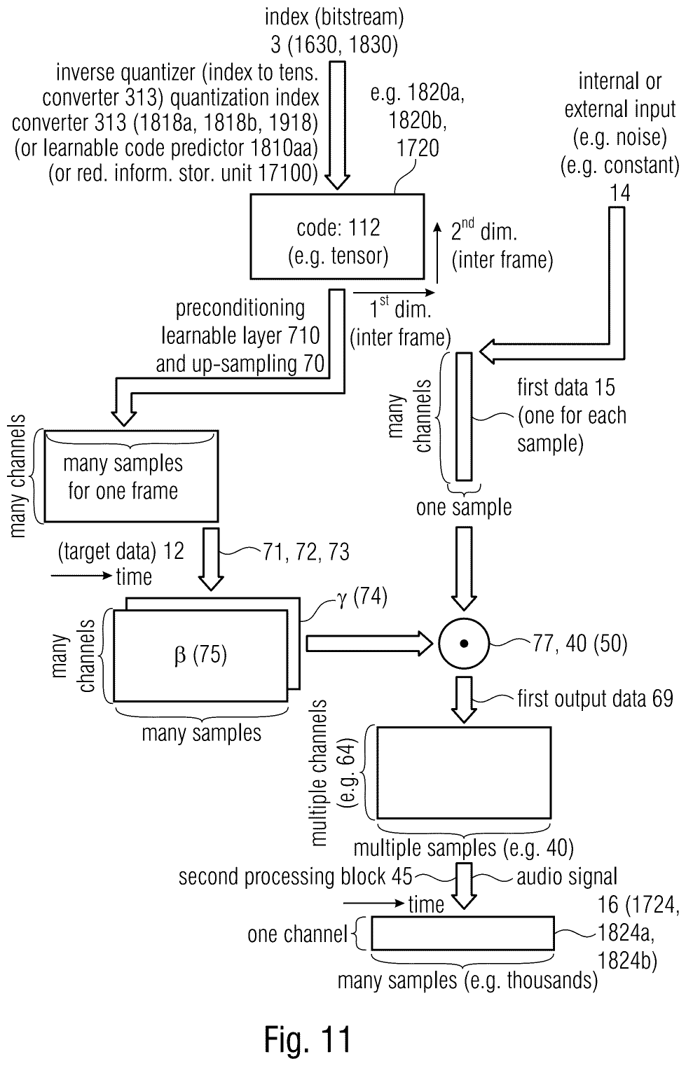

Reference is now mainly made to FIG. 11. A bitstream 3 (e.g. 1630 or 1830) may be subdivided onto a plurality of frames, which are however encoded in the form of indexes (e.g. as obtained from the quantizer). From the indexes of the bitstream 3 (e.g. 1630 or 1830), codes (e.g. scalars, vectors or more in general tensors) 112 are obtained through the quantization index converter 313 (1810a, 1810b, 1718). First and second dimensions are shown in codes 112 of FIG. 11 (other dimensions may be present). Each frame is subdivided into a plurality of samples in the abscissa direction (first, inter frame dimension). A different terminology may be “frame index” for the abscissa direction (first direction) and “feature map depth”, “latent dimension or coded parameter dimension). In the ordinate direction (second, intra frame dimension), a plurality of channels are provided). The codes 112 (1820a, 1820b, 1720) may be used by the preconditioning learnable layer(s) 710 (e.g. recurrent learnable layer(s)) to generate target data 12, which may also be in at least two dimensions (e.g. multi-dimensional), such as in the form of a spectrogram (e.g., a mel-spectrogram). Each target data 12 may represent one single frame and the sequence of frames may evolve, in the abscissa direction (from left to right) with time, along the first, inter frame dimension. Several channels may be in the ordinate direction (second, intra frame dimension) for each frame. For example, different coefficients will take place in different entries of each column in association with coefficients associated with the frequency bands. Conditioning learnable layer(s) 71, 72, 73, generate feature parameter(s) 74, 75 (β and γ). The abscissa (second, intra frame dimension) of β and γ is associated to different samples of the same frame, while the ordinate (first, inter frame dimension) is associated to different channels. In parallel, the first data provisioner 702 may provide the first data 15. A first data 15 may be generated for each sample and may have many channels. At the styling element 77 (and more in general, at the first conditioning block 40) the conditioning feature parameters β and γ (74, 75) may be applied to the first data 15. For example, an element-by-element multiplication may be performed between a column of the styling conditions 74, 75 (conditioning feature parameters) and the first data 15 or an evolution thereof. It will be shown that this process may be reiterated many times.

As clear from above, the first output data 69 generated by the first processing block 40 may be obtained as a 2-dimensional matrix (or even a tensor with more than two dimensions) with samples in abscissa (first, inter frame dimension) and channels in ordinate (second, intra frame dimension). Through the second processing block 45, the audio signal 16 may be generated having one single channel and multiple samples (e.g., in a shape similar to the input audio signal), in particular in the time domain. More in general, at the second processing block 45, the number of samples per frame (bitrate) of the first output data 69 may evolve from a second number of samples per frame (second bitrate) to a third number of samples per frame (third bitrate), higher than the second number of samples per frame (second bitrate). On the other side, the number of channels of the first output data 69 may evolve from a second number of channels to a third number of channels, which is less than the second number of channels. Said in other terms, the bitrate (third bitrate) of the output audio signal 16 (e.g. 1724, 1824a, 1824b) may be higher than the bitrate of the first data 15 (first bitrate) and of the bitrate (second bitrate) of the first output data 69, while the number of channels of the output audio signal 16 (e.g. 1724, 1824a, 1824b) may be lower than the number of channels of the first data 15 (first number of channels) and of the number of channels (second number of channels) of the first output data 69.

The models processing the of coded parameters frame-by-frame by juxtaposing the current frame to the previous frames already in the state are also called streaming or stream-wise models and may be used as convolution maps for convolutions for real-time and stream-wise applications like speech coding.

Examples of convolutions are discussed here below and it can be understood that they may be used at any of the preconditional learnable layer(s) 710 (e.g. recurrent learnable layer(s)), at least one conditional learnable layers 71, 72, 73, and more in general, in the first processing block 40 (50). In general terms, the arriving set of conditional parameters (e.g., for one frame) may be stored in a queue (not shown) to be subsequently processed by the first or second processing block while the first or second processing block, respectively, processes a previous frame.

A discussion on the operations mainly performed in blocks downstream to the preconditioning learnable layer(s) 710 (e.g. recurrent learnable layer(s)) is now provided. We take into account the target data 12 already obtained from the preconditioning learnable layer(s) 710, and which are applied to the conditioning learnable layer(s) 71-73 (the conditioning learnable layer(s) 71-73 being, in turn, applied to the stylistic element 77). Blocks 71-73 and 77 may be embodied by a generator network layer 770. The generator network layer 770 may include a plurality of learnable layers (e.g. a plurality of blocks 50a-50h, see below).

FIG. 9 (and its embodiment in FIG. 10) shows an example of an audio decoder (generator) 10 which can decode (e.g. generate, synthesize) an audio signal (output signal) 16 from the bitstream 3 (e.g. 1630 or 1830), e.g. according to the present techniques (also called StyleMelGAN). The output audio signal 16 (e.g. 1724, 1824a, 1824b) may be generated based on the input signal 14 (also called latent signal and which may be noise, e.g. white noise (“first option”), or which can be obtained from another source. The target data 12 may, as explained above, comprise (e.g. be) a spectrogram (e.g., a mel-spectrogram), the spectrogram (e.g. mel-spectrogram) providing mapping, for example, of a sequence of time samples onto mel scale (e.g. obtained from the preconditioning learnable layer(s) 710). The target data 12 and/or the first data 15 is/are in general to be processed, in order to obtain a speech sound recognizable as natural by a human listener. In the decoder 1700, 1800a, 1800b, the first data 15 obtained from the input is styled (e.g. at block 77) to have a vector (or more in general a tensor) with the acoustic features conditioned by the target data 12. At the end, the output audio signal 16 (e.g. 1724, 1824a, 1824b) will be recognized as speech by a human listener, in the case it is speech. The input vector 14 and/or the first data 15 (e.g. noise e.g. obtained from an internal or external source) may be, like in FIG. 10, a 128×1 vector (one single sample, e.g. time domain samples or frequency domain samples, and 128 channels) (FIG. 10 shows the input signal 14, to be provided to the channel mapping 30, the first data provisioner 702 not being shown or being considered to be the same as the channel mapping 30). A different length of the input vector 14 could be used in other examples. The input vector 14 may be processed (e.g. under the conditioning of the target data 12 obtained from the bitstream 3 (e.g. 1630 or 1830) through the preconditioning layer(s) 710) in the first processing block 40. The first processing block 40 may include at least one, e.g. a plurality of, processing blocks 50 (e.g. 50a . . . 50h). In FIG. 10 there are shown eight blocks 50a . . . 50h (each of them is also identified as “TADEResBlock”), even though a different number may be chosen in other examples. In many examples, the processing blocks 50a, 50b, etc. provide a gradual upsampling of the signal which evolves from the input signal 14 to the final audio signal 16 (e.g. 1724, 1824a, 1824b) (e.g., at least some processing blocks, e.g. 50a, 50b, 50c, 50d, 50e increases the sampling rate, in such a way that each of them increases the sampling rate (bitrate) in output with respect to the sampling rate in its input), while some other processing blocks (e.g. 50f-50h) (e.g. downstream with respect to those (e.g. 50a, 50b, 50c, 50d, 50e) which increase the sampling rate) do not increase the sampling rate (bitrate). The blocks 50a-50h may be understood as forming one single block 40 (e.g. the one shown in FIG. 9). In the first processing block 40, a conditioning set of learnable layers (e.g., 71, 72, 73, but different numbers are possible) may be used to process the target data 12 and the input signal 14 (e.g., first data 15). Accordingly, conditioning feature parameters 74, 75 (also referred to as gamma, γ, and beta, β) may be obtained, e.g. by convolution, during training. The learnable layer(s) 71-73 may therefore be part of a weight layer of a learning network. As explained above, the first processing block(s) 40, 50 may include at least one styling element 77 (normalization block 77). The at least one styling element 77 may output the first output data 69 (when there are a plurality of processing blocks 50, a plurality of styling elements 77 may generate a plurality of components, which may be added to each other to obtain the final version of the first output data 69). The at least one styling element 77 may apply the conditioning feature parameters 74, 75 to the input signal 14 (latent) or the first data 15 obtained from the input signal 14.

The first output data 69 may have a plurality of channels. The generated audio signal 16 (e.g. 1724, 1824a, 1824b) may have one single channel.

The audio generator (e.g. decoder) 10 may include a second processing block 45 (in FIG. 10 shown as including the blocks 42, 44, 46, 110). The second processing block 45 may be configured to combine the plurality of channels (indicated with 47 in FIG. 10) of the first output data 69 (inputted as second input data or second data), to obtain the output audio signal 16 (e.g. 1724, 1824a, 1824b) in one single channel, but in a sequence of samples (in FIG. 10, the samples are indicated with 49).

The “channels” are not to be understood in the context of stereo sound, but in the context of neural networks (e.g. convolutional neural networks) or more in general of the learnable units. For example, the input signal (e.g. latent noise) 14 may be in 128 channels (in the representation in the time domain), since a sequence of channels are provided. For example, when the signal has 40 samples and 64 channels, it may be understood as a matrix of 40 columns and 64 rows, while when the signal has 20 samples and 64 channels, it may be understood as a matrix of 20 columns and 64 rows (other schematizations are possible). Therefore, the generated audio signal 16 (e.g. 1724, 1824a, 1824b) may be understood as a mono signal. In case stereo signals are to be generated, then the disclosed technique is simply to be repeated for each stereo channel, so as to obtain multiple audio signals 16 which are subsequently mixed.

At least the original input audio signal and/or the generated speech 16 may be a sequence of time domain values. To the contrary, the output of each (or at least one of) the blocks 30 and 50a-50h, 42, 44 may have in general a different dimensionality (e.g. bi-dimensional or other multi-dimensional tensors). In at least some of the blocks 30 and 50a-50e, 42, 44, the signal (14, 15, 59, 69), evolving from the input 14 (e.g. noise) towards becoming speech 16, may be upsampled. For example, at the first block 50a among the blocks 50a-50h, a 2-times upsampling may be performed. An example of upsampling may include, for example, the following sequence: 1) repetition of same value, 2) insert zeros, 3) another repeat or insert zero+linear filtering, etc.

The generated audio signal 16 (e.g. 1724, 1824a, 1824b) may generally be a single-channel signal. In case multiple audio channels are necessary (e.g., for a stereo sound playback) then the procedure may be in principle iterated multiple times.

Analogously, also the target data 12 may have multiple channels (e.g. in spectrogram, such as mel-spectrogram), as generated by the preconditioning learnable layer(s) 710. In some examples, the target data 12 may be upsampled (e.g. by a factor of two, a power of 2, a multiple of 2, or a value greater than 2, e.g. by a different factor, such as 2.5 or a multiple thereof) to adapt to the dimensions of the signal (59a, 15, 69) evolving along the subsequent layers (50a-50h, 42), e.g. to obtain the conditioning feature parameters 74, 75 in dimensions adapted to the dimensions of the signal.

If the first processing block 40 is instantiated in multiple blocks (e.g. 50a-50h), the number of channels may, for example, remain at least some of the multiple blocks (e.g., from 50e to 50h and in block 42 the number of channels does not change). The first data 15 may have a first dimension or at least one dimension lower than that of the audio signal 16 (e.g. 1724, 1824a, 1824b). The first data 15 may have a total number of samples across all dimensions lower than the audio signal 16 (e.g. 1724, 1824a, 1824b). The first data 15 may have one dimension lower than the audio signal 16 (e.g. 1724, 1824a, 1824b) but a number of channels greater than the audio signal 16 (e.g. 1724, 1824a, 1824b).

Examples may be performed according to the paradigms of generative adversarial networks (GANs). A GAN includes a GAN generator 11 (FIG. 10) and a GAN discriminator 100 (FIG. 10). The GAN generator 11 tries to generate an audio signal 16 (e.g. 1724, 1824a, 1824b), which is as close as possible to a real audio signal. The GAN discriminator 100 shall recognize whether the generated audio signal 16 (e.g. 1724, 1824a, 1824b) is real or fake. Both the GAN generator 11 and the GAN discriminator 100 may be obtained as neural networks (or other by other learnable techniques). The GAN generator 11 shall minimize the losses (e.g., through the method of the gradients or other methods), and update the conditioning features parameters 74, 75 (and/or the codebook) by taking into account the results at the GAN discriminator 100. The GAN discriminator 100 shall reduce its own discriminatory loss (e.g., through the method of gradients or other methods) and update its own internal parameters. Accordingly, the GAN generator 11 is trained to generate better and better audio signals 16, while the GAN discriminator 100 is trained to recognize real signals 16 from the fake audio signals generated by the GAN generator 11. The GAN generator 11 may include the functionalities of the decoder 1700, 1800a, 1800b, without at least the functionalities of the GAN discriminator 100. Therefore, in most of the foregoing, the GAN generator 11 and the audio decoder 1700, 1800a, 1800b may have more or less the same features, apart from those of the discriminator 100. The audio decoder 1700, 1800a, 1800b may include the discriminator 100 as an internal component. Therefore, the GAN generator 11 and the GAN discriminator 100 may concur in constituting the audio decoder 1700, 1800a, 1800b. In examples where the GAN discriminator 100 is not present, the audio decoder 1700, 1800a, 1800b can be constituted uniquely by the GAN generator 11.

As explained by the wording “conditioning set of learnable layers”, the audio decoder 1700, 1800a, 1800b may be obtained according to the paradigms of conditional neural networks (e.g. conditional GANs), e.g. based on conditional information. For example, conditional information may be constituted by target data (or upsampled version thereof) 12 from which the conditioning set of layer(s) 71-73 (weight layer) are trained and the conditioning feature parameters 74, 75 are obtained. Therefore, the styling element 77 is conditioned by the learnable layer(s) 71-73. The same may apply to the preconditional layers 710.

The examples at the encoder 1600a, 1600b (or at the audio signal representation generator 1610a, 1610b) and/or at the encoded audio signal representation decoder 1710, 1810a, 1810b (or more in general audio generator) 10 may be based on convolutional neural networks. For example, a little matrix (e.g., filter or kernel), which could be a 3×3 matrix (or a 4×4 matrix, or 1×1, or less than 10×10 etc.), is convolved (convoluted) along a bigger matrix (e.g., the channel×samples latent or input signal and/or the spectrogram and/or the spectrogram or upsampled spectrogram or more in general the target data 12), e.g. implying a combination (e.g., multiplication and sum of the products; dot product, etc.) between the elements of the filter (kernel) and the elements of the bigger matrix (activation map, or activation signal). During training, the elements of the filter (kernel) are obtained (learnt) which are those that minimize the losses. During inference, the elements of the filter (kernel) are used which have been obtained during training. Examples of convolutions may be used at at least one of blocks 71-73, 61b, 62b (see below), 230, 250, 290, 429, 440, 460. Notably, instead of matrixes, also three-dimensional tensors (or tensors with more than three dimensions) may be used. Where a convolution is conditional, then the convolution is not necessarily applied to the signal evolving from the input signal 14 towards the audio signal 16 (e.g. 1724, 1824a, 1824b) through the intermediate signals 59a (15), 69, etc., but may be applied to the target signal 14 (e.g. for generating the conditioning feature parameters 74 and 75 to be subsequently applied to the first data 15, or latent, or prior, or the signal evolving form the input signal towards the speech 16). In other cases (e.g. at blocks 61b, 62b, see below) the convolution may be non-conditional, and may for example be directly applied to the signal 59a (15), 69, etc., evolving from the input signal 14 towards the audio signal 16 (e.g. 1724, 1824a, 1824b). Both conditional and non-conditional convolutions may be performed.

It is possible to have, in some examples (at the decoder or at the encoder), activation functions downstream to the convolution (ReLu, TanH, softmax, etc.), which may be different in accordance to the intended effect. ReLu may map the maximum between 0 and the value obtained at the convolution (in practice, it maintains the same value if it is positive, and outputs 0 in case of negative value). Leaky ReLu may output x if x>0, and 0.1*x if x≤0, x being the value obtained by convolution (instead of 0.1 another value, such as a predetermined value within 0.1±0.05, may be used in some examples). TanH (which may be implemented, for example, at block 63a and/or 63b) may provide the hyperbolic tangent of the value obtained at the convolution, e.g. TanH(x)=(e^{x}−e^{-x})/(e^{x}+e^{-x}), with x being the value obtained at the convolution (e.g. at block 61b, see below). Softmax (e.g. applied, for example, at block 64b) may apply the exponential to each element of the elements of the result of the convolution, and normalize it by dividing by the sum of the exponentials. Softmax may provide a probability distribution for the entries which are in the matrix which results from the convolution (e.g. as provided at 62b). After the application of the activation function, a pooling step may be performed (not shown in the figures) in some examples, but in other examples it may be avoided. It is also possible to have a softmax-gated TanH function, e.g. by multiplying (e.g. at 65b, see below) the result of the TanH function (e.g. obtained at 63b, see below) with the result of the softmax function (e.g. obtained at 64b). Multiple layers of convolutions (e.g. a conditioning set of learnable layers) may, in some examples, be one downstream to another one and/or in parallel to each other, so as to increase the efficiency. If the application of the activation function and/or the pooling are provided, they may also be repeated in different layers (or maybe different activation functions may be applied to different layers, for example) (this may also apply to the encoder).

At the audio signal representation decoder 1710, 1810a, 1810b (or audio generator 1700, 1800a, 1800b), the input signal 14 is processed, at different steps, to become the generated audio signal 16 (e.g. 1724, 1824a, 1824b) (e.g. under the conditions set by the conditioning set(s) of learnable layer(s) or the learnable layer(s) 71-73, and on the parameters 74, 75 learnt by the conditioning set(s) of learnable layer(s) or the learnable layer(s) 71-73). Therefore, the input signal 14 (or its evolved version, i.e. the first data 15) can be understood as evolving in a direction of processing (from 14 to 16) towards becoming the generated audio signal 16 (e.g. 1724, 1824a, 1824b) (e.g. speech). The conditions will be substantially generated based on the target signal 12 and/or on the preconditions in the bitstream 3 (e.g. 1630 or 1830), and on the training (so as to arrive at the most preferable set of parameters 74, 75).

It is also noted that the multiple channels of the input signal 14 (or any of its evolutions) may be considered to have a set of learnable layers and a styling element 77 associated thereto. For example, each row of the matrixes 74 and 75 may be associated to a particular channel of the input signal (or one of its evolutions), e.g. obtained from a particular learnable layer associated to the particular channel. Analogously, the styling element 77 may be considered to be formed by a multiplicity of styling elements (each for each row of the input signal x, c, 12, 76, 76′, 59, 59a, 59b, etc.).

FIG. 10 shows an example of the audio decoder (or more in general audio generator) 10 (which may embody the audio decoder 1700, 1800a, 1800b), and which may also comprise (e.g. be) a GAN generator 11 (see below). FIG. 10 does now show the preconditioning learnable layer 710 (shown in FIG. 9), even though the target data 12 are obtained from the bitstream 3 (e.g. 1630 or 1830) through the preconditioning layer(s) 710 (see above). The target data 12 may be a mel-spectrogram (or other tensor(s)) obtain from the preconditioning learnable layer 710 (but they may be other kinds of tensor(s)); the input signal 14 may be a latent (prior) noise or a signal obtained from internal or external source, and the output 16 may be speech. The input signal 14 may have only one sample and multiple channels (indicated as “x”, because they can vary, for example the number of channels can be 80 or something else). The input vector 14 may be obtained in a vector with 128 channels (but other numbers are possible). In case the input signal 14 is noise (“first option”), it may have a zero-mean normal distribution, and follow the formula z˜ [symbol] (0, 1₁₂₈); it may be a random noise of dimension 128 with mean 0, and with an autocorrelation matrix (square 128×128) equal to the identity I (different choice may be made). Hence, in examples in which the noise is used as input signal 14, it can be completely decorrelated between the channels and of variance 1 (energy). [symbol] (0, 1₁₂₈) may be realized at every 22528 generated samples (or other numbers may be chosen for different examples); the dimension may therefore be 1 in the time axis and 128 in the channel axis. In examples, the input signal 14 may be a constant value.

The input vector 14 may be step-by-step processed (e.g., at blocks 702, 50a-50h, 42, 44, 46, etc.), so as to evolve to speech 16 (the evolving signal will be indicated, for example, with different signals 15, 59a, x, c, 76′, 79, 79a, 59b, 79b, 69, etc.).

At block 30, a channel mapping may be performed. It may consist of or comprise a simple convolution layer to change the number channels, for example in this case from 128 to 64. Block 30 may therefore be learnable (in some examples, it is deterministic). As can be seen, at least some of the processing blocks 50a, 50b, 50c, 50d, 50e, 50f, 50g, 50h (altogether embodying the first processing block 50 of FIG. 6) may increase the number of samples by performing an upsampling (e.g., maximum 2-upsampling), e.g. for each frame. The number of channels may remain the same (e.g., 64) along blocks 50a, 50b, 50c, 50d, 50e, 50f, 50g, 50h. The samples may be, for example, the number of samples per second (or other time unit): we may obtain, at the output of block 50h, sound at 16 kHz or more (e.g. 22 Khz). As explained above, a sequence of multiple samples may constitute one frame. Each of the blocks 50a-50h (50) can also be a TADEResBlock (residual block in the context of TADE, Temporal Adaptive DEnormalization). Notably, each block 50a-50h (50) may be conditioned by the target data (e.g., codes, which may be tensors, such as a multidimensional tensor, e.g. with 2, 3, or more dimensions) 12 and/or by the bitstream 3 (e.g. 1630 or 1830) At a second processing block 45, only one single channel may be obtained, and multiple samples are obtained in one single dimension (see also FIG. 11). As can be seen, another TADEResBlock 42 (further to blocks 50a-50h) may be used (which reduces the dimensions to four single channels). Then, a convolution layer 44 and an activation function (which may be TanH 46, for example) may be performed. A (Pseudo Quadrature Mirror Filter)-bank) 110 may also be applied, so as to obtain the final 16 (and, possibly, stored, rendered, etc.).

At least one of the blocks 50a-50h (or each of them, in particular examples) and 42, as well as the encoder layers 230, 240 and 250 (and 430, 440, 450, 460), may be, for example, a residual block. A residual learnable block (layer) may operate a prediction to a residual component of the signal evolving from the input signal 14 (e.g. noise) to the output audio signal 16 (e.g. 1724, 1824a, 1824b). The residual signal is only a part (residual component) of the main signal evolving form the input signal 14 towards the output signal 16. For example, multiple residual signals may be added to each other, to obtain the final output audio signal 16 (e.g. 1724, 1824a, 1824b). Other architectures may be notwithstanding used.

FIG. 12 shows an example of one of the blocks 50a-50h (50). The blocks 50a-50h (50) may be replica with each other, although, when trained, they may result to As can be seen, each block 50 (50a-50h) is inputted with a first data 59a, which is either the first data 15, (or the upsampled version thereof, such as that output by the upsampling block 30) or the output from a preceding block. For example, the block 50b may be inputted with the output of block 50a; the block 50c may be inputted with the output of block 50b, and so on. In examples, different blocks may operate in parallel to each other, and there results are added together. From FIG. 12 it is possible to see that the first data 59a provided to the block 50 (50a-50h) or 42 is processed and its output is the output data 69 (which will be provided as input to the subsequent block). As indicated by the line 59a′, a main component of the first data 59a actually bypasses most of the processing of the first processing block 50a-50h (50). For example, blocks 60a, 900, 60b and 902 and 65b are bypassed by the main component 59a′. The residual component 59a of the first data 59 (15) may be processed to obtain a residual portion 65b′ to be added to the main component 59a′ at an adder 65c (which is indicated in FIG. 12, but not shown). The bypassing main component 59a′ and the addition at the adder 65c may be understood as instantiating the fact that each block 50 (50a-50h) processes operations to residual signals, which are then added to the main portion of the signal. Therefore, each of the blocks 50a-50h can be considered a residual block. The addition at adder 65c does not necessarily need to be performed within the residual block 50 (50a-50h). A single addition of a plurality of residual signals 65b′ (each outputted by each of residual blocks 50a-50h) can be performed (e.g., at one single adder block in the second processing block 45, for example). Accordingly, the different residual blocks 50a-50h may operate in parallel with each other. In the example of FIG. 12, each block 50 (50a-50h) may repeat its convolution layers twice. A first denormalization block 60a and a second denormalization block 60b may be used in cascade. The first denormalization block 60a may include an instance of the stylistic element 77, to apply the conditioning feature parameters 74 and 75 to the first data 59 (15) (or its residual version 59a). The first denormalization block 60a may include a normalization block 76. The normalization block 76 may perform a normalization along the channels of the first data 59 (15) (e.g. its residual version 59a). The normalized version c (76′) of the first data 59 (15) (or its residual version 59a) may therefore be obtained. The stylistic element 77 may therefore be applied to the normalized version c (76′), to obtain a denormalized (conditioned) version of the first data 59 (15) (or its residual version 59a). The denormalization at element 77 may be obtained, for example, through an element-by-element multiplication of the elements of the matrix (or more in general tensor) γ (which embodies the condition 74) and the signal 76′ (or another version of the signal between the input signal and the speech), and/or through an element-by-element addition of the elements of the matrix (or more in general tensor) B (which embodies the condition 75) and the signal 76′ (or another version of the signal between the input signal and the speech). A denormalized version 59b (conditioned by the conditioning feature parameters 74 and 75) of the first data 59 (15) (or its residual version 59a) may therefore be obtained.

Then, a gated activation 900 may be performed on the denormalized version 59b of the first data 59 (e.g. its residual version 59a). In particular, two convolutions 61b and 62b may be performed (e.g., each with 3×3 kernel and with dilation factor 1). Different activation functions 63b and 64b may be applied respectively to the results of the convolutions 61b and 62b. The activation 63b may be TanH. The activation 64b may be softmax. The outputs of the two activations 63b and 64b may be multiplied by each other, to obtain a gated version 59c of the denormalized version 59b of the first data 59 (or its residual version 59a). Subsequently, a second denormalization 60b may be performed on the gated version 59c of the denormalized version 59b of the first data 59 (or its residual version 59a). The second denormalization 60b may be like the first denormalization and is therefore here not described. Subsequently, a second activation 902 may performed. Here, the kernel may be 3×3, but the dilation factor may be 2. In any case, the dilation factor of the second gated activation 902 may be greater than the dilation factor of the first gated activation 900. The conditioning set of learnable layer(s) 71-73 (e.g. as obtained from the preconditioning learnable layer(s)) and the styling element 77 may be applied (e.g. twice for each block 50a, 50b . . . ) to the signal 59a. An upsampling of the target data 12 may be performed at upsampling block 70, to obtain an upsampled version 12′ of the target data 12. The upsampling may be obtained through non-linear interpolation, and may use e.g. a factor of 2, a power of 2, a multiple of two, or another value greater than 2. Accordingly, in some examples it is possible to have that the spectrogram (e.g. mel-spectrogram) 12′ has the same dimensions (e.g. conform to) the signal (76, 76′, c, 59, 59a, 59b, etc.) to be conditioned by the spectrogram. In examples, the first and second convolutions at 61b and 62b, respectively downstream to the TADE block 60a or 60b, may be performed at the same number of elements in the kernel (e.g., 9, e.g., 3×3). However, the second convolutions in block 902 may have a dilation factor of 2. In examples, the maximum dilation factor for the convolutions may be 2 (two).

As explained above, the target data 12 may be upsampled, e.g. so as to conform to the input signal (or a signal evolving therefrom, such as 59, 59a, 76′, also called latent signal or activation signal). Here, convolutions 71, 72, 73 may be performed (an intermediate value of the target data 12 is indicated with 71′), to obtain the parameters γ (gamma, 74) and β (beta, 75). The convolution at any of 71, 72, 73 may also require a rectified linear unit, ReLu, or a leaky rectified linear unit, leaky ReLu. The parameters γ and β may have the same dimension of the activation signal (the signal being processed to evolve from the input signal 14 to the generated audio signal 16 (e.g. 1724, 1824a, 1824b), which is here represented as x, 59, 59a, or 76′ when in normalized form). Therefore, when the activation signal (x, 59, 59a, 76′) has two dimensions, also γ and β (74 and 75) have two dimensions, and each of them is superimposable to the activation signal (the length and the width of γ and β may be the same of the length and the width of the activation signal). At the stylistic element 77, the conditioning feature parameters 74 and 75 are applied to the activation signal (which may be the first data 59a or the 59b output by the multiplier 65a). It is to be noted, however, that the activation signal 76′ may be a normalized version (at instance norm block 76) of the first data 59, 59a, 59b (15), the normalization being in the channel dimension. It is also to be noted that the formula shown in stylistic element 77 (γc+β, also indicated with γ⊙c+β in FIG. 12) may be an element-by-element product, and in some examples is not a convolutional product or a dot product. The convolutions 72 and 73 have not necessarily activation function downstream of them. The parameter γ (74) may be understood as having variance values and β (75) as having bias values. It is noted that for each block 50a-50h, 42, the learnable layer(s) 71-73 (e.g. together with the styling element 77) may be understood as embodying weight layers. Also, block 42 of FIG. 10 may be instantiated as block 50 of FIG. 12. Then, for example, a convolutional layer 44 will reduce the number of channels to 1 and, after that, a TanH 46 is performed to obtain speech 16. The output 44′ of the blocks 44 and 46 may have a reduced number of channels (e.g. 4 channels instead of 64), and/or may have the same number of channels (e.g., 40) of the previous block 50 or 42.

A PQMF synthesis (see also below) 110 is performed on the signal 44′, so as to obtain the audio signal 16 (e.g. 1724, 1824a, 1824b) in one channel.

Quantization and Conversion from Indexes onto Codes

At first, it is to be noted that it is not strictly necessary that one single index is used to map one single code (e.g. tensor). There may be techniques such as:
Split tensor quantization:
   At the encoder (e.g. 1600a, 1600b) the quantizer 1608 converts one single tensor onto a plurality of indexes, e.g. by:
      Splitting the tensor onto a plurality of subtensors (e.g. subvectors) (e.g. at specific coordinates or positions in the tensor)
      Providing one index for each subtensor.
      For this aim, different codebooks for different portions of the tensor may be defined
      In some cases, there may be defined a main portion of the tensor (e.g. main subtensor) and at least one low-ranking portion of the tensor (e.g. low-ranking subtensor)
      The quantizer 1608 will therefore convert each subtensor in a respective index, using the respective codebook
   At the audio signal representation decoder (e.g. 1710, 1810a, 1810b), the quantization index converter converts a plurality of indexes for each tensor, e.g. by
      converting each index onto a respective subtensor
      putting together the subtensors into one single tensor.
      Analogously to the encoder, different codebooks may be used.
Residual quantization:
   At the encoder (e.g. 1600a, 1600b) the quantizer 1608 converts one single tensor onto a plurality of indexes, e.g. by
      Iteratively decomposing the current tensor onto a main portion ad at least one residual portion (e.g. error)
      For each portion of the tensor, a conversion may be performed using a particular index.
      Even in this case, there may be used a plurality of codebooks (e.g. main codebook and residual codebook(s)
   At the audio signal representation decoder (e.g. 1710, 1810a, 1810b), the quantization index converter converts a plurality of indexes for each tensor e.g. by
      Converting each index onto each portion (main portion, residual portion) of the tensor (the same high-ranking codebooks as in the encoder may be used)
      Composing all the portions together (e.g. by addition)

Portions of the tensors may, in some examples, components (e.g. addends).

Here below, reference is made in particular to the residual quantization, even if analogous concepts may be used for the split quantization.

There are here discussed the operations of the quantizer 1608 (e.g. in FIG. 6a or 6b) and of the quantization index converter 313, (inverse or reverse quantizer) when it is a quantization index. It is noted that quantizer may be inputted with a scalar, a vector, or more in general a tensor, and the quantization index converter 313 (1818a, 1818b, 1718) converts an index onto at least one code (which is taken from a codebook).

The codebooks that are used my be, for example, codebooks 1622 and 1624 (and possibly also 1122, 1124, 1124a, 1124b of FIG. 1a).

Here, the following conventions are used:
x is the speech (or more in general input signal 1602 to be encoded)
E(x) is the output of the audio signal generator 1604, which may be a vector or more in general a tensor
Indexes (e.g. i_{z}, iᵣ, i_{q}) which refer (e.g. point) to codes (e.g. z, r, q) are in at least one codebook (e.g. zₑ, rₑ, qₑ)
The indexes (e.g. i_{z}, iᵣ, i_{q}) are written in the bitstream 3 (e.g. 1630 or 1830) by the quantizer 1608 and are read by the quantization index converter 313 (1818a, 1818b, 1718)
A main code (e.g. z) is chosen in such a way to approximate the value E(x)
A first (if present) residual code (e.g. r) is chosen in such a way to approximate the residual E(x)−z
A second (if present) residual code (e.g. q) is chosen in such a way to approximate the residual E(x)−z−r
The decoder (e.g. at the quantization index converter 313, 1718, 1818a, 1818b) reads the indexes (e.g. i_{z}, iᵣ, i_{q}) from the bitstream 3 (e.g. 1630 or 1830), obtains the codes (e.g. z, r, q), and reconstructs a tensor (e.g. a tensor which represents the frame in the first audio signal representation 220 of the first audio signal 1), e.g. by summing the codes (e.g. z+r+q) as tensor 112.
Dithering can be added, to avoid potential clustering effect.

The quantizer 1608 of FIG. 6a or 6b may associate, to each tensor of the first multi-dimensional audio signal representation or a processed version of the first multi-dimensional audio signal representation of the input audio signal 1602, a code which best approximates the tensor (e.g. a code which minimizes the distance from the tensor) of the codebook, so as to permit to write in the bitstream 3 the index which, in the codebook, is associated to the code which minimizes the distance.

As explained above, the at least one codebook may be defined according to a residual technique. For example there may be:
1) A main (base) codebook zₑ (e.g. 1622, 1122) may be defined as having a plurality of codes, so that a particular code z∈zₑ in the codebook is chosen which is associated approximating the main portion of the frame E(x) (input vector) outputted by the block 290;
2) An optional first residual codebook rₑ (e.g. 1624, 1124), having a plurality of codes, may be defined, so that a particular code r∈rₑ is chosen which best approximates the residual E(x)−z of the main portion of the input vector E(x);
3) An optional second residual codebook qₑ (e.g. 1124a), having a plurality of codes, may be defined, so that a particular code q∈qₑ is chosen which approximates the first-rank residual E(x)−zₑ−rₑ;
4) Possible optional further lower ranked residual codebooks.

The codes of each codebook may be indexed according to indexes, and the association between each code in the codebook and the index may be obtained by training. What is written in the bitstream 3 (e.g. 1630 or 1830) is the index for each portion (main portion, first residual portion, second residual portion). For example, we may have:
1) A first index i_{z} pointing at z∈zₑ
2) A second index iᵣ pointing at the first residual r∈rₑ
3) A third index iᵣ pointing at the second residual q∈qₑ

While the codes z, r, q may have the dimensions of the output E(x) of the audio signal representation generator 1604 for each frame, the indexes i_{z}, iᵣ, i_{q} may be their encoded versions (e.g., a string of bits, such as 10 bits).

Therefore, there may be a multiplicity of residual codebooks, so that:
the second residual codebook qₑ associates, to indexes to be encoded in the audio signal representation, codes (e.g. scalar, vectors or more in general tensors) representing second residual portions of the first multi-dimensional audio signal representation of the input audio signal,
the first residual codebook rₑ associates, to indexes to be encoded in the audio signal representation, codes representing first residual portions of frames of the first multi-dimensional audio signal representation,
the second residual portions of frames being residual [e.g. low-ranked] with respect to the first residual portions of frames.

Dually, the audio generator 1700, 1800a, 1800b (or the audio signal representation decoder 1710, 1810a, 1810b, or in particular the quantization index converter 1718, 1818a, 1818b) may perform the reverse operation. The audio generator 1700, 1800a, 1800b may have a codebook which may to convert the indexes (e.g. i_{z}, iᵣ, i_{q}) of the bitstream (1630, 1830) onto codes (e.g. z, r, q) from the codes in the codebook.

For example, in the residual case of above, the bitstream may present, for each frame of the bitstream 3 (1630, 1830):
1) A main index i_{z} representing a code z∈zₑ for converting from the index (code) i_{z} to the code z, thereby forming a main portion z of the tensor (e.g. vector) approximating E(x)
2) A first residual index (second index) iᵣ representing the code r∈rₑ for converting from the index iᵣ to the code r, thereby forming a first residual portion of the tensor (e.g. vector) approximating E(x)
3) A second residual index (third index) i_{q} representing the code q∈r_{q} for converting from the index i_{q} to the code q, thereby forming a second residual portion of the tensor (e.g. vector) approximating E(x)

Then the code version (tensor version) 212 of the frame may be obtained, for example, as sum z+r+q.

### GAN Discriminator

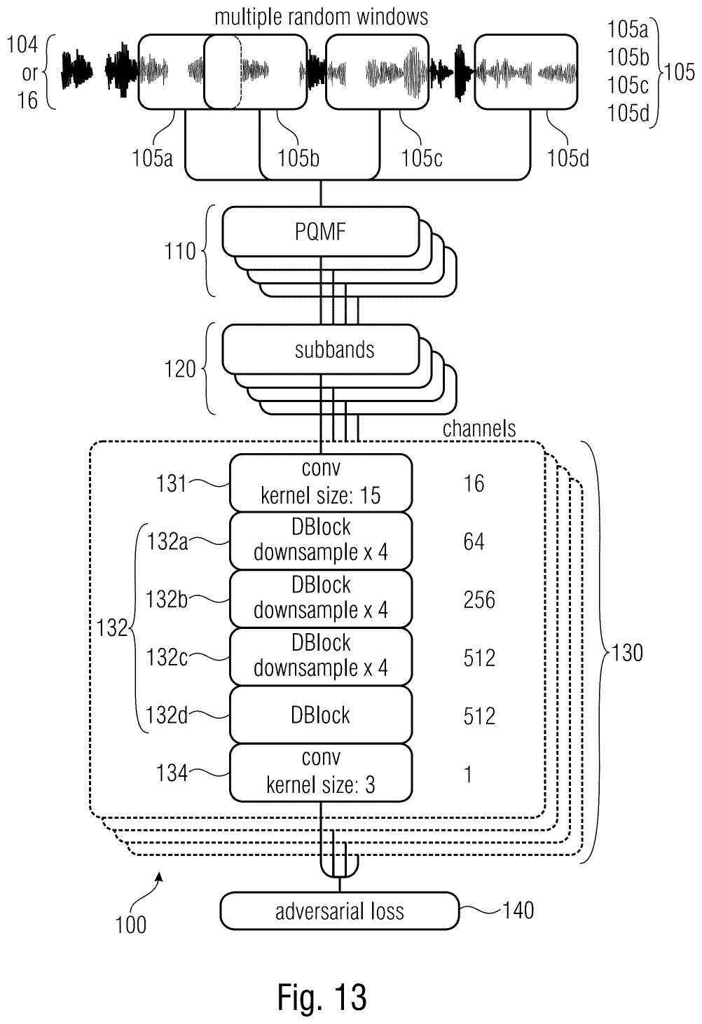

The GAN discriminator 100 of FIG. 13 may be used during training for obtaining, for example, the parameters 74 and 75 to be applied to the input signal 12 (or a processed and/or normalized version thereof). The training may be performed before inference, and the parameters (e.g. 74, 75, and/or the at least one codebook) may be, for example, stored in a non-transitory memory and used subsequently (however, in some examples it is also possible that the parameters 74 or 75 are calculated on line).

The GAN discriminator 100 has the role of learning how to recognize the generated audio signals (e.g., audio signal 16 (e.g. 1724, 1824a, 1824b) synthesized as discussed above) from real input signals (e.g. real speech) 104. Therefore, the role of the GAN discriminator 100 is mainly exerted during a training session (e.g. for learning parameters 72 and 73) and is seen in counter position of the role of the GAN generator 11 (which may be seen as the audio decoder 1700, 1800a, 1800b without the GAN discriminator 100).

In general terms, the GAN discriminator 100 may be input by both audio signal 16 (e.g. 1724, 1824a, 1824b) synthesized generated by the GAN decoder 1700, 1800a, 1800b (and obtained from the bitstream 3 (e.g. 1630 or 1830), which in turn could be generated by the encoder 1600a or 1600b from the input audio signal 1602), and real audio signal (e.g., real speech) 104 acquired e.g., through a microphone or from another source, and process the signals to obtain a metric (e.g., loss) which is to be minimized. The real audio signal 104 can also be considered a reference audio signal. During training, operations like those explained above for synthesizing speech 16 may be repeated, e.g. multiple times, so as to obtain the parameters 74 and 75, for example.

In examples, instead of analyzing the whole reference audio signal 104 and/or the whole generated audio signal 16 (e.g. 1724, 1824a, 1824b), it is possible to only analyze a part thereof (e.g. a portion, a slice, a window, etc.). Signal portions generated in random windows (105a-105d) sampled from the generated audio signal 16 (e.g. 1724, 1824a, 1824b) and from the reference audio signal 104 are obtained. For example random window functions can be used, so that it is not a priori pre-defined which window 105a, 105b, 105c, 105d will be used. Also the number of windows is not necessarily four, at may vary.

Within the windows (105a-105d), a PQMF (Pseudo Quadrature Mirror Filter)-bank 110 may be applied. Hence, subbands 120 are obtained. Accordingly, a decomposition (110) of the representation of the generated audio signal (16) or the representation of the reference audio signal (104) is obtained.

An evaluation block 130 may be used to perform the evaluations. Multiple evaluators 132a, 132b, 132c, 132d (complexively indicated with 132) may be used (different number may be used). In general, each window 105a, 105b, 105c, 105d may be input to a respective evaluator 132a, 132b, 132c, 132d. Sampling of the random window (105a-105d) may be repeated multiple times for each evaluator (132a-132d). In examples, the number of times the random window (105a-105d) is sampled for each evaluator (132a-132d) may be proportional to the length of the representation of the generated audio signal or the representation of the reference audio signal (104). Accordingly, each of the evaluators (132a-132d) may receive as input one or several portions (105a-105d) of the representation of the generated audio signal (16) or the representation of the reference audio signal (104).

Each evaluator 132a-132d may be a neural network itself. Each evaluator 132a-132d may, in particular, follow the paradigms of convolutional neutral networks. Each evaluator 132a-132d may be a residual evaluator. Each evaluator 132a-132d may have parameters (e.g. weights) which are adapted during training (e.g., in a manner similar to one of those explained above).

As shown in FIG. 13, each evaluator 132a-132d also performs a downsampling (e.g., by 4 or by another downsampling ratio). The number of channels may increase for each evaluator 132a-132d (e.g., by 4, or in some examples by a number which is the same of the downsampling ratio).

Upstream and/or downstream to the evaluators, convolutional layers 131 and/or 134 may be provided. An upstream convolutional layer 131 may have, for example, a kernel with dimension 15 (e.g., 5×3 or 3×5). A downstream convolutional layer 134 may have, for example, a kernel with dimension 3 (e.g., 3×3).

During training, a loss function (adversarial loss) 140 may be optimized. The loss function 140 may include a fixed metric (e.g. obtained during a pretraining step) between a generated audio signal (16) and a reference audio signal (104). The fixed metric may be obtained by calculating one or several spectral distortions between the generated audio signal (16) and the reference audio signal (104). The distortion may be measured by keeping into account:
magnitude or log-magnitude of the spectral representation of the generated audio signal (16) and the reference audio signal (104), and/or
different time or frequency resolutions.

In examples, the adversarial loss may be obtained by randomly supplying and evaluating a representation of the generated audio signal (16) or a representation of the reference audio signal (104) by one or more evaluators (132). The evaluation may comprise classifying the supplied audio signal (16, 132) into a predetermined number of classes indicating a pretrained classification level of naturalness of the audio signal (14, 16). The predetermined number of classes may be, for example, “REAL” vs “FAKE”.

Examples of losses may be obtained as

$$ℒ ( D ; G ) = {E}_{x , z} [ ReLU ( 1 - D ( x ) ) + ReLU ( 1 + D ( G ( z ; s ) ) ) ] ,$$

where:
   x is the real speech 104,
   z is the latent input 14 (which may be noise or another input obtained from the bitstream 3 (e.g. 1630 or 1830)),
   s is the tensor representing x (or more in general the target signal 12).
   D( . . . ) is the output of the evaluators in terms of distribution of probability (D( . . . )=0 meaning “for sure fake”, D ( . . . )=1 meaning “for sure real”).

The spectral reconstruction loss [symbol] _{rec} is still used for regularization to prevent the emergence of adversarial artifacts. The final loss is can be, for example:

$$ℒ = \frac{1}{4} {Σ}_{i = 1}^{4} ℒ ( {D}_{i} ; G ) + {ℒ}_{rec} .$$

where each i is the contribution at each evaluator 132a-132d (e.g., each evaluator 132a-132d providing a different Dᵢ) and [symbol] _{rec} is the pretrained (fixed) loss.

During training session, there is a search for the minimum value of [symbol] , which may be expressed for example as

$${min}_{G} ( {E}_{z} [ {\sum }_{i = 1}^{4} - {D}_{i} G ( s , z ) ] + {ℒ}_{rec} )$$

Other kinds of minimizations may be performed.

In general terms, the minimum adversarial losses 140 are associated to the best parameters (e.g., 74, 75) to be applied to the stylistic element 77.
1) It is to be noted that the training session, also the encoder 1600a or 1600b (or at least the audio signal representation generator 1604) may be trained together with the decoder 1700, 1800a, 1800b (or more in general audio generator 10). Therefore, together with the parameters of the decoder 1700, 1800a, 1800b (or more in general audio generator 10), also the parameter of the encoder 1600a or 1600b (or at least the audio signal representation generator 1604) may be obtained. In particular, at least one of the following may be obtained by training: The weights of the learnable layers 230, 250 (e.g., kernels)
2) The weights of the recurrent learnable layer 240
3) The weights of the learnable block 290, including the weights (e.g., kernels) of the layers 429, 440, 460
4) The codebook(s) (e.g. at least one of zₑ, rₑ, qₑ) to be used by the learnable quantizer (dually to the codebook(s) of the quantization index converter 313).

A general way to train the encoder 1600a or 1600b and the decoder 1700, 1800a, 1800b one together with the other is to use a GAN, in the discriminator 100 shall discriminate between:
audio signals 16 generated from frames in the bitstreams 3 actually generated by the encoder 1; and
audio signals 16 generated from frames in bitstreams non-generated by the encoder 1.

### Generation of at Least One Codebook

With particular attention to the codebook(s) (e.g. at least one of zₑ, rₑ, qₑ) to be used by the quantizer 1608 and/or by the quantization index converter 1818a, 1818b, 1718 (313), there may be different way of defining the codebook(s).

During the training session a multiplicity of bitstreams 3 (1630, 1830) may be generated by the quantizer 1608 and are obtained by the quantization index converter 313 (1818a, 1818b, 1718). Indexes (e.g. i_{z}, iᵣ, i_{q}) are written in the bitstreams (3) to encode known frames representing known audio signals. The training session may include an evaluation of the generated audio signals 16 at the audio signal representation decoder 1800a, 1800b, 1700 in respect to the known input audio signals 1602 provided to the audio signal representation generator 1610a, 1610b: associations of indexes of the at least one codebook are adapted with the frames of the encoded bitstreams [e.g. by minimizing the difference between the generated audio signal 16 (e.g. 1724, 1824a, 1824b) and the known audio signals 1602].

In the cases in which a GAN is used, the discriminator 100 shall discriminate between:
audio signals 16 (e.g. 1724, 1824a, 1824b) generated from frames in the bitstreams 3 (1630, 1830) actually generated by the encoder 1600a, 1600b; and
audio signals 16 generated in bitstreams non-generated by the encoder 1600a, 1600b.

During the training session it is possible to define the length of the indexes (e.g., 10 bits instead of 15 bits) for each index. The training may therefore provide at least:
a multiplicity of first bitstreams with first candidate indexes having a first bitlength and being associated with first known frames representing known audio signals, the first candidate indexes forming a first candidate codebook, and
a multiplicity of second bitstreams with second candidate indexes having a second bitlength and being associated with known frames representing the same first known audio signals, the second candidate indexes forming a second candidate codebook.

The first bitlength may be higher than the second bitlength [and/or the first bitlength has higher resolution but it occupies more band than the second bitlength]. The training session may include an evaluation of the generated audio signals obtained from the multiplicity of the first bitstreams in comparison with the generated audio signals obtained from the multiplicity of the second bitstreams, to thereby choose the codebook [e.g. so that the chosen learnable codebook is the chosen codebook between the first and second candidate codebooks] [for example, there may be an evaluation of a first ratio between a metrics measuring the quality of the audio signal generated from the multiplicity of first bitstreams in respect to the bitlength vs a second ratio between a metrics measuring the quality of the audio signal generated from the multiplicity of second bitstreams in respect to the bitrate, and to choose the bitlength which maximizes the ratio] [e.g. this can be repeated for each of the codebooks, e.g., the main, the first residual, the second residual, etc.]. The discriminator 100 may evaluate whether the outputs signal 16 generated using the second candidate codebook with low bitlength indexes appear to be similar to outputs signal 16 generated using fake bitstreams 3 (e.g. by evaluating a threshold of the minimum value of [symbol] and/or an error rate at the discriminator 100), and in positive case the second candidate codebook with low bitlength indexes will be chosen; otherwise, the first candidate codebook with high bitlength indexes will be chosen.

In addition or alternative, the training session may performed by using:
a first multiplicity of first bitstreams with first indexes associated with first known frames representing known audio signals, wherein the first indexes are in a first maximum number, the first multiplicity of first candidate indexes forming a first candidate codebook; and
a second multiplicity of second bitstreams with second indexes associated with known frames representing the same first known audio signals, the second multiplicity of second candidate indexes forming a second candidate codebook, wherein the second indexes are in a second maximum number different from the first maximum number.

### DISCUSSION

### Principles of Our Invention

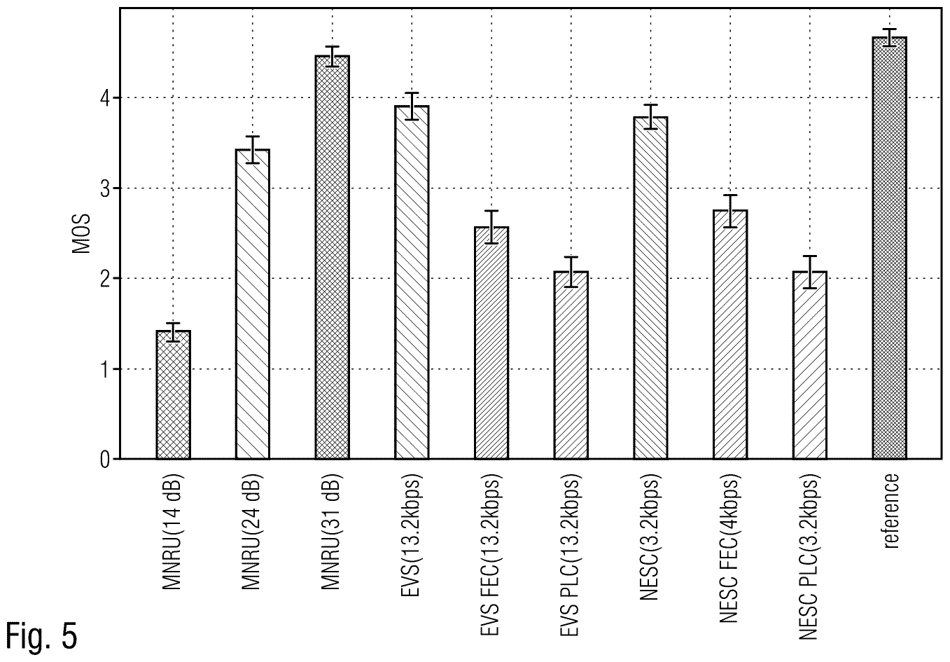

We propose, inter alia, a DNN based auto-regressive network for PLC (also called PLCNet) that can be deeply integrated with our previously proposed codec NESC[7]. NESC is an end-to-end speech codec comprising of a neural encoder and a neural decoder. The neural encoder learns a latent representation from speech signal and vector quantize it at a bitrate of 3.2 kbps. The neural decoder uses the quantized representation as a conditioning feature to synthesize the original signal. The proposed PLCNet works on the latent representation of the pretrained NESC model and predicts future latent representation for concealment. PLCnet (mainly shown in FIGS. 1b and 2, as well as FIGS. 8a and 8b) has given good results (see FIGS. 4 and 5).

We also propose FEC mode (e.g. in FIGS. 6a and 6b for the encoder side, and in FIG. 7 for the decoder side) for NESC such that past latent representation can be sent along with the current frame for concealment as well as assist the PLCNet for larger burst errors. The FEC is self-contained and is another description of at least one past frame. FEC can be exploited in case a (de)-Jitter Buffer Management is performed at the receiver side. It avoids at low cost retransmission, muting or concealment of lost frames, and therefore improve significantly the resilience of the system. The FEC mode may come with additional bitrate of 0.8 kbps to 3.2 kbps depending upon the number of past frames (in range of 1 to 4 in our implementation) to be sent to the decoder and/or the desired quality in case of packet losses and/or the desired total bit-rate.

### PLCNet and FEC:

PLCNet:
   NESC may include residual quantization with e.g. 4 codebooks.
   First codebook (e.g. 1622, 1222, etc.) may be primary representation that can produce accepted quality of speech signal, thus, making it alone suitable for concealment.
   PLCNet may be trained independently of the codec.
   Use of memory element like GRU in PLCNet facilitates auto-regressive feature generation for burst error concealment.
Forward Error Correction (FEC):
   New FEC for neural codec.
   Made possible, in some examples, because of availability of future frames in jitter buffer (e.g. see FIGS. 3a and 3b).
   Redundant frame contains information of past primary frame and is transmitted along with current primary frame.
   The choice of the past frame to be considered in the redundant frame may depend on the jitter buffer length and/or network conditions and may be called ‘FEC offset’.
   The redundant frame can contain single codebook stage index (e.g. 0.8 kbps) or all codebook stage indices (e.g. 3.2 kbps) depending on desired quality of corrected packets.
   Or, the redundant frame can contain information on multiple past frames (e.g. 4 different past frames with 4 different FEC offset for payload of 3.2 kbps over the primary frame) for correcting even more efficiently in very bad network conditions.
   Option of having a dedicated codebook for the redundant information that is trained on the latent representation.

### Listening Test Results:

Reference may be made to FIG. 4.
Dataset: MS Challenge PLC dataset, max burst loss of 120 ms and 320 ms.
Frame error rate between 4%-30%
NESC PLC: the proposed approach for concealment using in deeply integrated estimation of the latent representation. The results are shown in FIG. 4
NESC/PLCNet: NESC with concealment from the conventional technology using another dedicated generative network used as post-processor of the lost frames (significant complexity overhead)

### Improvements/Novelty FEC:

New method of FEC dedicated to neural codecs, using redundant information of the past frames.
   The new FEC operating in latent space does not require additional learning layers and involves minimal structural change of the neural coders which allows a simple and powerful integration.
   FEC is performed with some stage/s of codebook or with entirely newly trained codebook.
New method of FEC dedicated to neural codecs, using redundant information of the current by frame
   The new FEC operating in latent space does not require additional learning layers and involves minimal structural change of the neural coders which allows a simple and powerful integration.
   FEC is performed with some stage/s of codebook or with entirely newly trained codebook.

### Improvements/Novelty PLC:

An autoregressive way of PLC in latent feature domain that predict future codebook indices and is trained independent to the neural codec.
Good concealment for burst size up to 120 ms and more and at error rates up to 30%.

### Summarizing of Some Aspects

In examples above, some aspects relate to an audio signal representation decoder configured to decode an audio signal representation from a bitstream, the bitstream being divided in a sequence of packets, the audio signal representation decoder comprising:
a bitstream reader, configured to sequentially read the sequence of packets [e.g. to extract at least one index within at least one current packet];
a packet loss controller, configured to check whether a current packet is well received [e.g. it has a correct format] or is to be considered as lost;
a quantization index converter, configured, in case the packet loss controller has determined that the current packet is well received [e.g. has correct format], to convert at least one index extracted from the current packet onto at least one current code [e.g. vector/tensor] from at least one codebook, thereby forming at least one portion of the audio signal representation; and
wherein the audio signal representation decoder is configured, in case the packet loss controller has determined that the current packet is to be considered as lost, to generate, through at least one learnable predictor layer, at least one current code by prediction [e.g. code prediction or index prediction] from at least one preceding code or index [e.g., the current code may be obtained by prediction from a previously obtained index or code, or, in alternative, a current index may be obtained by prediction from a previously obtained index or code] [the prediction may be based on a previously predicted code or index or on a previously converted code from a correctly received index or from a code converted from a previously predicted index], thereby forming at least one portion of the audio signal representation.
[e.g. there may be a processing and/or rendering block, configured, in case the packet loss controller has determined that the at least one current packet has correct format, to generate at least one portion of the audio signal by converting the at least one converted code [e.g. through at least one learnable processing layer, at least one a deterministic layer, or at least one learnable processing layer and at least one deterministic layer] onto the at least portion of the audio signal; and a code predictor, wherein the processing block is configured to generate at least one portion of the audio signal by converting the at least one predicted code [e.g. through at least one learnable processing layer, at least one a deterministic layer, or at least one learnable processing layer and at least one deterministic layer] onto the at least portion of the audio signal].

In examples above, some aspects relate to an audio signal representation decoder, wherein the at least one codebook associates indexes to codes or parts of codes, so that the quantization index converter converts the at least one index extracted from the current packet onto the at least one converted code, or at least one part of a converted code.

In examples above, some aspects relate to an audio signal representation decoder, wherein the at least one codebook [e.g. zₑ, rₑ, qₑ] includes:
a base codebook [e.g. zₑ] associating indexes to main portions of codes; and
at least one low-ranking codebook [e.g. a first low-ranking codebook, e.g. rₑ and maybe a second low-ranking codebook with ranking lower than the first low-ranking codebook, and maybe a third low-ranking codebook with ranking lower than the second low-ranking codebook; and maybe a fourth low-ranking codebook with ranking lower than the third low-ranking codebook; further codebooks are possible] associating indexes to residual portions of codes [e.g. the lower the ranking the more residual the portion of code],
wherein the at least one index extracted from the current packet includes at least one high-ranking index and at least one low-ranking index,
wherein the quantization index converter is configured to convert the at least one high-ranking index onto a main portion of the current code, and the at least one low-ranking index onto at least one residual portion of the current code,
wherein the quantization index converter is further configured to reconstruct the current code by adding the main portion to the at least one residual portion.

In examples above, some aspects relate to an audio signal representation decoder, configured to predict at least one current code from at least the at least one high-ranking index of the at least one preceding or following packet, but not from the lowest-ranking index of the of the at least one preceding or following packet.

In examples above, some aspects relate to an audio signal representation decoder, configured to predict the current code from at least the high-ranking index of the at least one preceding packet and from at least one middle-ranking index, but not from the lowest-ranking index of the of the at least one preceding packet.

In examples above, some aspects relate to an audio signal representation decoder, configured to store redundancy information written in packets of the bitstream but referring to different packets, the audio signal representation decoder being configured to store the redundancy information in a temporary storage unit,
wherein the audio signal representation decoder is configured, in case the at least one current packet is to be considered as lost, to search the temporary storage unit, and, in case the redundancy information referring to the at least one current packet is retrieved, to:
retrieve at least one index from the redundancy information referring to the current packet;
cause the quantization index converter to convert the at least one retrieved index from the at least one codebook onto a substitutive code;
cause the processing block to generate the at least one portion of the audio signal by converting the at least one substitutive code onto the at least portion of the audio signal.

In examples above, some aspects relate to an audio signal representation decoder, wherein the redundancy information provides at least the high-ranking index(es) of the at least one preceding or following packet, but not at least one of the lower-ranking index(es) of the at least one preceding or following packet.

In examples above, some aspects relate to an audio signal representation decoder further comprising at least one learnable predictor configured to perform the prediction, the at least one learnable predictor having at least one learnable predictor layer.

In examples above, some aspects relate to an audio signal representation decoder, wherein the at least one learnable predictor is trained by sequentially predicting predicted current codes, or respectively current indexes, from preceding and/or following packets, and by comparing the predicted current codes, or the current codes obtained from predicted indexes, with converted codes converted from packets having been well received, so as to learn learnable parameters of the at least one learnable predictor layer which minimize errors of the predicted current codes with respect the converted codes converted from the packets having correct format.

In examples above, some aspects relate to an audio signal representation decoder, wherein the at least one learnable predictor layer includes at least one recurrent learnable layer.

In examples above, some aspects relate to an audio signal representation decoder, wherein the at least one learnable predictor layer includes at least one gated recurrent unit.

In examples above, some aspects relate to an audio signal representation decoder, wherein the at least one learnable predictor layer has at least one state,
the at least one learnable predictor layer being iteratively instantiated, along a sequential plurality of learnable predictor layer instantiations,
in such a way that, to predict the current code, a current learnable predictor layer instantiation receives a state from at least one preceding learnable predictor layer instantiation which has predicted at least one preceding code for at least one preceding packet.

In examples above, some aspects relate to an audio signal representation decoder, wherein, to predict the current code, the current learnable predictor layer instantiation receives in input:
the at least one preceding converted code in case the at least one preceding packet is considered well received; and
the at least one preceding predicted code in case the at least one preceding packet is considered as lost.

In examples above, some aspects relate to an audio signal representation decoder, wherein, to predict the current code, the current learnable predictor layer instantiation receives the state from the at least one preceding iteration both in case the at least one preceding packet is considered well received and in case the at least one preceding packet is considered as lost.

In examples above, some aspects relate to an audio signal representation decoder, wherein the at least one learnable predictor layer is configured to predict the current code and/or to receive the state from the at least one preceding learnable predictor layer instantiation both in case the at least one preceding packet is considered well received and in case the at least one preceding packet is considered as lost, so as to provide the predicted code and/or to output the state to at least one subsequent learnable predictor layer instantiation.

In examples above, some aspects relate to an audio signal representation decoder, wherein the current learnable predictor layer instantiation includes at least one learnable convolutional unit.

In examples above, some aspects relate to an audio signal representation decoder, wherein the current learnable predictor layer instantiation includes at least one learnable recurrent unit.

In examples above, some aspects relate to an audio signal representation decoder, wherein the at least one recurrent unit of the current learnable layer is inputted with a state from a correspondent at least one recurrent unit from the at least one preceding learnable predictor layer instantiation, and outputs a state to a corresponding at least one recurrent unit of at least one subsequent learnable predictor layer instantiation.

In examples above, some aspects relate to an audio signal representation decoder, wherein the current learnable predictor layer instantiation has a series of learnable layers [e.g. each learnable layer of the series, apart from the last one, outputs a processed code to the immediately subsequent layer of the series, and the last learnable layer of the series output a code to the immediately subsequent learnable predictor layer instantiation] [e.g. for each learnable predictor layer instantiation, apart from the last learnable predictor layer instantiation, each learnable layer of the series outputs its state to the corresponding learnable layer of the immediately learnable predictor layer instantiation]

In examples above, some aspects relate to an audio signal representation decoder, wherein for the current learnable predictor layer instantiation, the series of learnable layers includes at least one dimension-reducing learnable layer [e.g. GRU2] and at least one dimension-increasing learnable layer [e.g. FC] subsequent to the at least one dimension-reducing learnable layer [e.g. so that the output of the learnable predictor layer instantiation has the same dimension of the input of the learnable predictor layer instantiation].

In examples above, some aspects relate to an audio signal representation decoder, wherein the at least one dimension-reducing learnable layer [e.g. GRU2] includes at least one learnable layer with a state, [e.g. in such a way that each learnable predictor layer instantiation, apart from the last learnable predictor layer instantiation, provides the state of the at least one dimension-reducing learnable layer to the at least one dimension-reducing learnable layer of the immediately subsequent learnable predictor layer instantiation].

In examples above, some aspects relate to an audio signal representation decoder, wherein the at least one dimension-increasing learnable layer [e.g. FC] includes at least one learnable layer without a state, [e.g. in such a way that no predictor layer instantiation provides the state of the at least one dimension-increasing learnable layer to the at least one dimension-increasing learnable layer of the immediately subsequent learnable predictor layer instantiation].

In examples above, some aspects relate to an audio signal representation decoder, wherein the series of learnable layers is gated.

In examples above, some aspects relate to an audio signal representation decoder, wherein the wherein the series of learnable layers is gated through a softmax activation function.

In examples above, some aspects relate to an audio signal representation decoder configured to decode an audio signal representation from a bitstream, the bitstream being divided in a sequence of packets, the audio signal representation decoder comprising:
a bitstream reader [e.g. index extractor], configured to sequentially read the sequence of packets, and to extract, from the at least one current packet:
   at least one index of the at least one current packet;
   redundancy information on at least one preceding or following packet, the redundancy information permitting to reconstruct at least one index within the at least one preceding or following packet;
a packet loss controller, PLC, configured to check whether the at least one current packet is well received [e.g. having a correct format] or is to be considered as lost [e.g. having an incorrect format];
a quantization index converter, configured, [e.g. in case the PLC has determined that the at least one current packet has correct format], to convert the at least one index of the at least one current packet onto at least one current converted code [e.g. tensor, or in particular case vector, but in case of vector it should preferably be with multiple dimensions] from at least one codebook, thereby forming a portion of the audio signal representation;
a redundancy information storage unit, configured, [e.g. through at least one learnable layer or a deterministic layer], to store the redundancy information and to provide the stored redundancy information on the at least one current packet in case the PLC has determined that the at least one current packet is to be considered as lost, to form a portion of the audio signal representation through the redundancy information [the redundancy information may include, for example, one index, or one portion of the index, to be converted by the quantization index converter, or a code or a portion of code previously already converted].
[e.g. as part of an audio generator it may comprise a processing and/or rendering block, configured, in case the PLC has determined that the at least one current packet has correct format, to generate at least one portion of the audio signal by converting the at least one converted code [e.g. through at least one learnable processing layer, at least one a deterministic layer, or at least one learnable processing layer and at least one deterministic layer] onto the at least portion of the audio signal];
[wherein the processing block is configured to generate at least one portion of the audio signal by converting the at least one stored redundancy information on the at least one current packet [e.g. through at least one learnable processing layer, at least one a deterministic layer, or at least one learnable processing layer and at least one deterministic layer] onto the at least portion of the audio signal].

In examples above, some aspects relate to an audio signal representation decoder, wherein the redundancy information storage unit is configured to store, as redundancy information, at least one index from a preceding or following packet, so as to provide, to the quantization index converter, the stored at least one index in case the PLC has determined that the at least one current packet is to be considered as lost.

In examples above, some aspects relate to an audio signal representation decoder, wherein the redundancy information storage unit is configured to store, as redundancy information, at least one code previously extracted from a preceding or following packet, to bypass the quantization index converter using the stored code in case in case the PLC has determined that the at least one current packet is to be considered as lost.

In examples above, some aspects relate to an audio signal representation decoder, wherein the at least one codebook associates indexes to codes or parts of codes, so that the quantization index converter converts the at least one index extracted from the current packet onto the at least one converted code, or at least one part of a converted code.

In examples above, some aspects relate to an audio signal representation decoder, wherein the at least one codebook [e.g. zₑ, rₑ, qₑ] includes:
a base codebook [e.g. zₑ] associating indexes to main portions of codes; and
at least one low-ranking codebook [e.g. a first low-ranking codebook, e.g. rₑ and maybe a second low-ranking codebook with ranking lower than the first low-ranking codebook, and maybe a third low-ranking codebook with ranking lower than the second low-ranking codebook; and maybe a fourth low-ranking codebook with ranking lower than the third low-ranking codebook; further codebooks are possible] associating indexes to residual portions of codes [e.g. the lower the ranking the more residual the portion of code],
wherein the at least one index extracted from the current packet includes at least one high-ranking index and at least one low-ranking index,
wherein the quantization index converter is configured to convert the at least one high-ranking index onto a main portion of the current code, and the at least one low-ranking index onto at least one residual portion of the current code,
wherein the quantization index converter is further configured to reconstruct the current code by adding the main portion to the at least one residual portion.

In examples above, some aspects relate to an audio signal representation decoder, configured to generate or retrieve the at least one current code from at least the at least one high-ranking index of the at least one preceding or following packet, but not from the lowest-ranking index of the of the at least one preceding or following packet.

In examples above, some aspects relate to an audio signal representation decoder, configured to generate or retrieve the current code from at least the high-ranking index of the at least one preceding or following packet and from at least one middle-ranking index, but not from the lowest-ranking index of the of the at least one preceding or following packet.

In examples above, some aspects relate to an audio generator for generating an audio signal from a bitstream, comprising the audio signal representation decoder as above,
further configured to generate the audio signal by converting the audio signal representation onto the audio signal.

In examples above, some aspects relate to an audio generator, further configured to render the generated audio signal.

In examples above, some aspects relate to an audio generator comprising:
a first data provisioner configured to provide, for a given frame, first data derived from an input signal [e.g. from an external or internal source or from the audio signal representation], [wherein the first data may have one single channel or multiple channels; the first data may be, for example, completely unrelated with the target data and/or with the audio signal representation, while in other examples the first data may have some relationship with the audio signal representation, since it may be obtained from the audio signal representation];
a first processing block, configured, for the given frame, to receive the first data and to output first output data in the given frame, [wherein the first output data may comprise a one single channel or a plurality of channels],
[e.g. the audio generator also comprising a second processing block, configured, for the given frame, to receive, as second data, the first output data or data derived from the first output data,]
wherein the first processing block comprises:
   [in some cases, at least one preconditioning learnable layer configured to receive the audio signal representation, or a processed version thereof, and, for the given frame, output target data representing the audio signal in the given frame [e.g. with multiple channels and multiple samples for the given frame]];
   at least one conditioning learnable layer configured, for the given frame, to process target data, from the decoded audio signal representation, to obtain conditioning feature parameters for the given frame; and
   a styling element, configured to apply the conditioning feature parameters to the first data or normalized first data
[wherein the second processing block, if present, may be configured to combine the plurality of channels of the second data to obtain the audio signal],
[the at least one preconditioning learnable layer may include at least one recurrent learnable layer [e.g. a gated recurrent learnable layer, such as a gated recurrent unit, GRU]]
[e.g. configured to obtain the audio signal from the first output data or a processed version of the first output data].

In examples above, some aspects relate to an audio generator configured so that the bitrate of the audio signal is greater than the bitrate of both the target data and/or of the first data and/or of the second data.

In examples above, some aspects relate to an audio generator, wherein the second processing block is configured to increase the bitrate of the second data, to obtain the audio signal [and/or wherein the second processing block is configured to reduce the number of channels of the second data, to obtain the audio signal].

In examples above, some aspects relate to an audio generator, wherein the first processing block is configured to up-sample the first data from a number of samples for the given frame to a second number of samples for the given frame greater than the first number of samples.

In examples above, some aspects relate to an audio generator, wherein the second processing block is configured to up-sample the second data obtained from the first processing block from a second number of samples for the given frame to a third number of samples for the given frame greater than the second number of samples.

In examples above, some aspects relate to an audio generator, configured to reduce the number of channels of the first data from a first number of channels to a second number of channels of the first output data which is lower than the first number of channels.

In examples above, some aspects relate to an audio generator, wherein the second processing block is configured to reduce the number of channels of the first output data, obtained from the first processing block, from a second number of channels to a third number of channels of the audio signal, wherein the third number of channels is lower than the second number of channels.

In examples above, some aspects relate to an audio generator, wherein the audio signal is a mono audio signal.

In examples above, some aspects relate to an audio generator, configured to obtain the input signal from the audio signal representation.

In examples above, some aspects relate to an audio generator configured to obtain the input signal from noise.

In examples above, some aspects relate to an audio generator, wherein the conditioning set of learnable layers comprises one or at least two convolution layers.

In examples above, some aspects relate to an audio generator, further comprising at least one preconditioning learnable layer configured to receive the audio signal representation, or a processed version thereof, and, for the given frame, output target data representing the audio signal in the given frame [e.g. with multiple channels and multiple samples for the given frame]

In examples above, some aspects relate to an audio generator, wherein the at least one preconditioning learnable layer is configured to provide the target data as a spectrogram or a decoded spectrogram.

In examples above, some aspects relate to an audio generator, wherein a first convolution layer is configured to convolute the target data or up-sampled target data to obtain first convoluted data using a first activation function.

In examples above, some aspects relate to an audio generator, wherein the conditioning learnable layer and the styling element are part of a weight layer in a residual block of a neural network comprising one or more residual blocks.

In examples above, some aspects relate to an audio generator, wherein the audio generator further comprises a normalizing element, which is configured to normalize the first data.

In examples above, some aspects relate to an audio generator, wherein the audio generator further comprises a normalizing element, which is configured to normalize the first data in the channel dimension.

In examples above, some aspects relate to an audio generator, wherein the audio signal is a voice audio signal.

In examples above, some aspects relate to an audio generator, wherein the target data is up-sampled by a factor of a power of 2 or by another factor, such as 2.5 or a multiple of 2.5.

In examples above, some aspects relate to an audio generator, wherein the target data is up-sampled by non-linear interpolation.

In examples above, some aspects relate to an audio generator, wherein the first processing block further comprises:
a further learnable layers, configured to process data derived from the first data using a second activation function,
wherein the second activation function is a gated activation function.

In examples above, some aspects relate to an audio generator, where the further set of learnable layers comprises one or two or more convolution layers.

In examples above, some aspects relate to an audio generator, wherein the second activation function is a softmax-gated hyperbolic tangent, TanH, function. In examples above, some aspects relate to an audio generator, wherein the first activation function is a leaky rectified linear unit, leaky ReLu, function.

In examples above, some aspects relate to an audio generator, wherein convolution operations run with maximum dilation factor of 2.

In examples above, some aspects relate to an audio generator comprising eight first processing blocks and one second processing block.

In examples above, some aspects relate to an audio generator, wherein the first data has one dimension which is lower than the audio signal.

In examples above, some aspects relate to an audio generator, wherein the target data is a spectrogram.

In examples above, some aspects relate to an encoder, comprising:
an audio signal representation generator configured to generate, through at least one learnable layer, an audio signal representation [e.g. using at least one learnable layer, e.g. a combination of a learnable layer and a deterministic layer] from an input audio signal, the audio signal representation including a sequence of tensors [each tensor may be a vector, but in case the tensor is a vector, it shall at least have two dimensions; each tensor/vector may be a code];
a quantizer configured to convert each current tensor of the sequence of tensors onto at least one index, wherein each index is obtained from at least one codebook associating a plurality of tensors to a plurality of indexes;
a bitstream writer configured to write packets in the bitstream, so that a current packet includes the at least one index for the current tensor of the sequence of tensors, wherein the encoder is configured to write redundancy information of the current tensor in at least one preceding or following packet of the bitstream different from the current packet.

In examples above, some aspects relate to an encoder, wherein the at least one codebook associates parts of tensors to indexes, so that the quantizer converts the current tensor onto a plurality of indexes.

In examples above, some aspects relate to an encoder, wherein the at least one codebook [e.g. zₑ, rₑ, qₑ] includes:
a base codebook [e.g. zₑ] associating main portions of tensors to indexes; and
at least one low-ranking codebook [e.g. a first low-ranking codebook, e.g. rₑ and maybe a second low-ranking codebook with ranking lower than the first low-ranking codebook, and maybe a third low-ranking codebook with ranking lower than the second low-ranking codebook; and maybe a fourth low-ranking codebook with ranking lower than the third low-ranking codebook; further codebooks are possible] associating residual portions of tensors to indexes,
wherein the at least one current tensor has at least one main portion and at least one residual portion,
wherein the quantizer is configured to convert the main portion of the at least one current tensor onto at least one high-ranking index, and the at least one residual portion of the at least one tensor onto at least one low-ranking index,
so that the bitstream writer writes, in the bitstream, both the high-ranking index and the at least one low-ranking index.

In examples above, some aspects relate to an encoder, configured to provide the redundancy information with at least the high-ranking index(es) of the at least one preceding or following packet, but not at least the lowest-ranking low-ranking index(es) of the same at least one preceding or following packet.

In examples above, some aspects relate to an encoder, configured to transmit the bitstream to a receiver [e.g. audio generator] through a communication channel.

In examples above, some aspects relate to an encoder, configured to monitor the payload state of the communication channel, so as, in case the payload state in the communication channel is over a predetermined threshold, to increase the quantity of redundancy information.

In examples above, some aspects relate to an encoder, configured:
in case the payload in the communication channel is below the predetermined threshold, to only transmit, as redundancy information, for each current packet, high-ranking indexes of the at least one preceding or following packet; and
in case the payload of the communication channel is over the predetermined threshold, to transmit, as redundancy information, for each current packet, both the high-ranking indexes of the at least one preceding or following packet and at least some low-ranking indexes of the same at least one preceding or following packet.

In examples above, some aspects relate to an encoder, configured to compute a packet offset between the current packet and the at least one preceding or following packet having the redundant information at least in function of the payload of the communication channel.

In examples above, some aspects relate to an encoder, configured to compute a packet offset between the current packet and the at least one preceding or following packet having the redundant information at least in function of the envisioned application.

In examples above, some aspects relate to an encoder, configured to compute a packet offset between the current packet and the at least one preceding or following packet having the redundant information at least in function of an input provided by the end-user.

In examples above, some aspects relate to an encoder, wherein the at least one codebook includes a redundancy codebook associating a plurality of tensors to a plurality of indexes, wherein the encoder is configured to write the redundancy information of the current tensor in the at least one preceding or following packet of the bitstream different from the current packet as an index received from the at least one quantization codebook.

### FURTHER CHARACTERIZATION OF FIGURES

FIGS. 1a and 1b: they may, in some examples, refer to Neural End-to-End Speech Codec (FIG. 1a) and proposed PLCNet (FIG. 1b)

FIG. 2: it may, in some examples, refer to a detailed block diagram of PLCNet (tensor dimension is given in brackets)

FIG. 3: it may, in some examples, refer to Forward Error correction method for NESC

FIG. 4: MUSHRA Listening Test for PLC with NESC

FIG. 5: P.800 Listening Test for PLC and FEC with NESC

### VARIANTS

Some variants and/or additional or alternative aspects are here discussed.

The implementation in hardware or in software may be performed using a digital storage medium, for example cloud storage, a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some examples according to the invention comprise a data carrier having electronically readable control signals, which are capable of cooperating with a programmable computer system, such that one of the methods described herein is performed.

Generally, examples of the present invention may be implemented as a computer program product with a program code, the program code being operative for performing one of the methods when the computer program product runs on a computer. The program code may for example be stored on a machine-readable carrier.

Other examples comprise the computer program for performing one of the methods described herein, stored on a machine-readable carrier. In other words, an example of the method is, therefore, a computer program having a program code for performing one of the methods described herein, when the computer program runs on a computer.

A further example of the methods is, therefore, a data carrier (or a digital storage medium, or a computer-readable medium) comprising, recorded thereon, the computer program for performing one of the methods described herein. A further example is, therefore, a data stream or a sequence of signals representing the computer program for performing one of the methods described herein. The data stream or the sequence of signals may for example be configured to be transferred via a data communication connection, for example via the Internet. A further example comprises a processing means, for example a computer, or a programmable logic device, configured to or adapted to perform one of the methods described herein. A further example comprises a computer having installed thereon the computer program for performing one of the methods described herein.

In some examples, a programmable logic device (for example a field programmable gate array) may be used to perform some or all of the functionalities of the methods described herein. In some examples, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An encoder, comprising:
an audio signal representation generator configured to generate, through at least one learnable layer, an audio signal representation as a representation of an audio signal, the audio signal representation comprising a sequence of tensors;
a quantizer configured to convert each current tensor of the sequence of tensors onto at least one index, wherein each index is obtained from at least one codebook associating a plurality of tensors to a plurality of indexes;
a bitstream writer configured to write packets in the bitstream, so that a current packet comprises the at least one index for the current tensor of the sequence of tensors,
wherein the encoder is configured to write redundancy information of the current tensor in at least one preceding or following packet of the bitstream different from the current packet and/or to write, in the current packet, redundancy information of a tensor, different from the current tensor, in the current packet.

2. The encoder of claim 1, wherein the at least one codebook associates parts of tensors to indexes, so that the quantizer converts the current tensor onto a plurality of indexes.

3. The encoder of claim 1, wherein the at least one codebook comprises:
a base codebook associating main portions of tensors to indexes; and
at least one low-ranking codebook associating residual portions of tensors to indexes,
wherein the at least one current tensor has at least one main portion and at least one residual portion,
wherein the quantizer is configured to convert the main portion of the at least one current tensor onto at least one high-ranking index, and the at least one residual portion of the at least one tensor onto at least one low-ranking index,
so that the bitstream writer writes, in the bitstream, both the high-ranking index and the at least one low-ranking index.

4. The encoder of claim 3, configured to provide the redundancy information with at least the high-ranking index(es) of the at least one preceding or following packet, but not at least the lowest-ranking low-ranking index(es) of the same at least one preceding or following packet.

5. The encoder of claim 1, configured to split the current tensor into a plurality of subtensors, so as to quantize each subtensor.

6. The encoder of claim 1, configured to decompose the current tensor among a main portion and at least one residual portion, so as to quantize the main portion and the at least one residual portion.

7. The encoder of claim 1, configured to transmit the bitstream to a receiver through a communication channel.

8. The encoder of claim 7, configured to monitor the payload state of the communication channel, so as, in case the payload state in the communication channel is over a predetermined threshold, to increase the quantity of redundancy information.

9. The encoder of claim 3, configured to transmit the bitstream to a receiver through a communication channel
and further configured to monitor the payload state of the communication channel, so as, in case the payload state in the communication channel is over a predetermined threshold, to increase the quantity of redundancy information
and further configured:
in case the payload in the communication channel is below the predetermined threshold, to only transmit, as redundancy information, for each current packet, high-ranking indexes of the at least one preceding or following packet; and/or
in case the payload of the communication channel is over the predetermined threshold, to transmit, as redundancy information, for each current packet, both the high-ranking indexes of the at least one preceding or following packet and at least some low-ranking indexes of the same at least one preceding or following packet.

10. The encoder of claim 8, configured to compute a packet offset between the current packet and the at least one preceding or following packet having the redundant information at least in function of the payload of the communication channel.

11. The encoder of claim 8, configured to compute a packet offset between the current packet and the at least one preceding or following packet having the redundant information at least in function of the envisioned application.

12. The encoder of claim 8, configured to compute a packet offset between the current packet and the at least one preceding or following packet having the redundant information at least in function of an input provided by the end-user.

13. The encoder of claim 9, configured to compute a packet offset between the current packet and the at least one preceding or following packet having the redundant information at least in function of the payload of the communication channel, in such a way that the higher the payload in the communication channel, or the higher the error rate in the communication channel, the higher the packet offset.

14. The encoder of claim 8, wherein the at least one codebook comprises a redundancy codebook associating a plurality of tensors to a plurality of indexes, wherein the encoder is configured to write the redundancy information of the current tensor in the at least one preceding or following packet of the bitstream different from the current packet as an index received from the at least one quantization codebook.

15. A method comprising:
generating, through at least one learnable layer, an audio signal representation as a representation of an audio signal, the audio signal representation comprising a sequence of tensors;
converting each current tensor of the sequence of tensors onto at least one index, wherein each index is obtained from at least one codebook associating a plurality of tensors to a plurality of indexes;
writing packets in a bitstream, so that a current packet comprises the at least one index for the current tensor of the sequence of tensors,
wherein the method comprises writing redundancy information of the current tensor in at least one preceding or following packet of the bitstream different from the current packet, and/or writing, in the current packet, redundancy information of at least one tensor to be written in at least one preceding or following packet of the bitstream different from the current packet.

16. A non-transitory digital storage medium having a computer program stored thereon to perform the method comprising:
generating, through at least one learnable layer, an audio signal representation as a representation of an audio signal, the audio signal representation comprising a sequence of tensors;
converting each current tensor of the sequence of tensors onto at least one index, wherein each index is obtained from at least one codebook associating a plurality of tensors to a plurality of indexes;
writing packets in a bitstream, so that a current packet comprises the at least one index for the current tensor of the sequence of tensors,
wherein the method comprises writing redundancy information of the current tensor in at least one preceding or following packet of the bitstream different from the current packet, and/or writing, in the current packet, redundancy information of at least one tensor to be written in at least one preceding or following packet of the bitstream different from the current packet,
when said computer program is run by a computer.
